(19) United States
(12) Patent Application Publication
(10) Pub. No.: US 2019/0210581 A1
(43) Pub. Date: Jul. 11, 2019

(54) Hydraulic Control Device and Brake System

(71) Applicant: Hitachi Automotive Systems, Ltd., Hitachinaka-shi, Ibaraki (JP)

(72) Inventor: Masayuki SAITO, Machida-shi, Tokyo (JP)

(21) Appl. No.: 16/329,795

(22) PCT Filed: Aug. 15, 2017
(86) PCT No.: PCT/JP2017/029333

§ 371 Date: Mar. 1, 2019

(30) Foreign Application Priority Data
Sep. 2, 2016 (JP) 2016-171366

(51) Int. Cl. B60T 13/68; B60T 13/18; B60T 17/18

(52) U.S. Cl. CPC B60T 13/68; F15B 2211/50518; B60T 17/18; B60T 13/18

(57) ABSTRACT

There is provided a hydraulic control device that improves the reliability. The hydraulic control device includes a rear-side connection fluid path, a front-side connection fluid path, a first discharge fluid path, a first hydraulic source, a second discharge fluid path, a second hydraulic source, and a shutoff valve. The rear-side connection fluid path connects a master cylinder with a rear-side wheel cylinder. The front-side connection fluid path connects the master cylinder with a front-side wheel cylinder. The first discharge fluid path is connected to the rear-side connection fluid path and to the front-side connection fluid path. The first hydraulic source is configured to discharge a brake fluid to the first discharge fluid path. The second discharge fluid path is connected to the front-side connection fluid path at a position between a connecting position of the first discharge fluid path and the front-side wheel cylinder. The second hydraulic source is configured to discharge the brake fluid to the second discharge fluid path. The shutoff valve is placed between the connecting position of the first discharge fluid path and a connecting position of the second discharge fluid path in the front-side connection fluid path.

### TECHNICAL FIELD

The present invention relates to a hydraulic control device.

### BACKGROUND ART

A conventionally known configuration of a hydraulic control device includes two hydraulic sources which discharge a brake fluid (as described in, for example, Patent Literature 1).

### CITATION LIST

### Patent Literature

Patent Literature 1: WO 2014/184840A

### SUMMARY OF INVENTION

### Technical Problem

The conventional hydraulic control device has room for improving the reliability.

### Solution to Problem

A hydraulic control device according to one embodiment of the present invention is preferably provided with one hydraulic source configured to supply a brake fluid to a wheel cylinder for a part of wheels and with the other hydraulic source configured to supply the brake fluid to a wheel cylinder for at least part of the remaining wheels.

This configuration improves the reliability.

### BRIEF DESCRIPTION OF DRAWINGS

FIG. 1 is a diagram illustrating the configuration of a brake system according to a first embodiment with a hydraulic circuit;

FIG. 2 is a diagram illustrating one example of the operating state according to the first embodiment at normal time of the brake system;

FIG. 3 is a diagram illustrating one example of the operating state of the brake system according to the first embodiment in the event of an abnormality;

FIG. 4 is a diagram illustrating the configuration of a brake system according to a second embodiment with a hydraulic circuit;

FIG. 5 is a diagram illustrating one example of the operating state of the brake system according to the second embodiment at the time of abnormality diagnosis;

FIG. 6 is a diagram illustrating the configuration of a brake system according to a third embodiment with a hydraulic circuit;

FIG. 7 is a diagram illustrating one example of the operating state of the brake system according to the third embodiment in the event of an abnormality;

FIG. 8 is a diagram illustrating the configuration of a brake system according to a fourth embodiment with a hydraulic circuit;

FIG. 9 is a diagram illustrating the configuration of a brake system according to a fifth embodiment with a hydraulic circuit;

FIG. 10 is a diagram illustrating one example of the operating state of the brake system according to the fifth embodiment in the event of an abnormality; and

FIG. 11 is a diagram illustrating the configuration of a brake system according to a sixth embodiment with a hydraulic circuit.

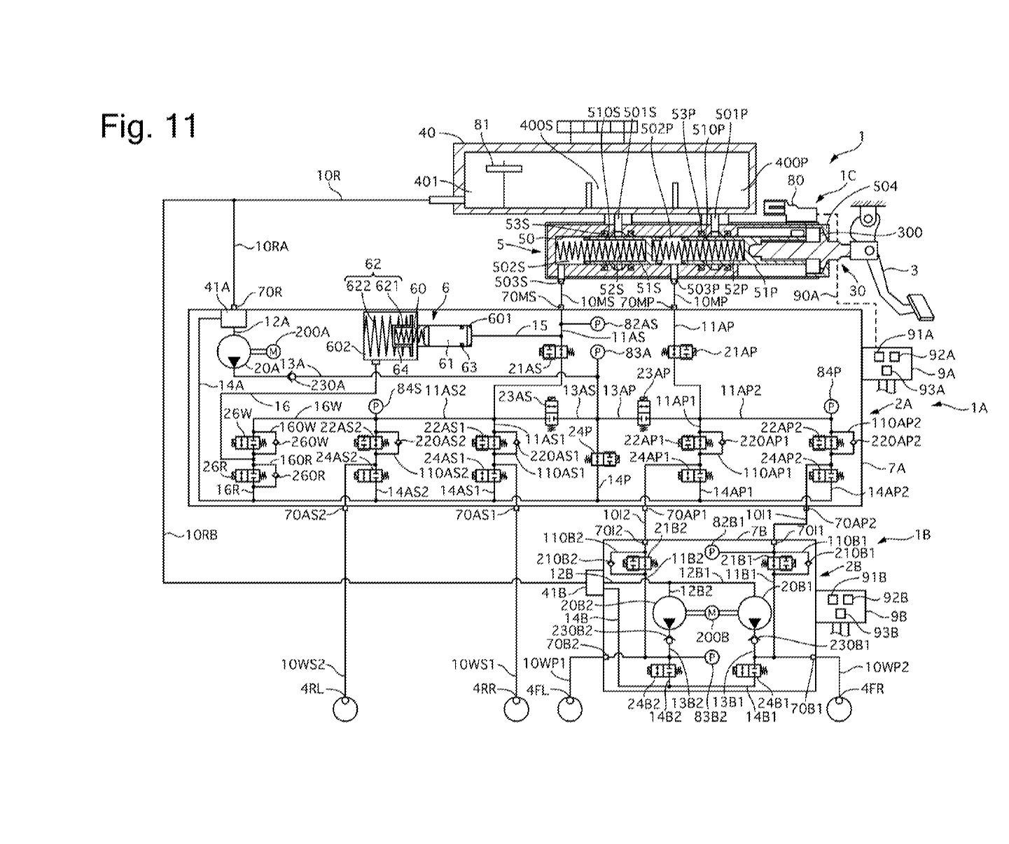

### DESCRIPTION OF EMBODIMENTS

Some embodiments of the present invention are described below with reference to drawings.

### First Embodiment

The following first describes a mechanical configuration. A brake system 1 according to this embodiment is applicable to, for example, a hybrid vehicle equipped with an electric motor (generator) in addition to an internal combustion engine (engine) as the prime mover which drives wheels and an electric vehicle equipped with only the electric motor, as well as a general vehicle equipped with only the internal combustion engine. The brake system 1 is a hydraulic control device configured to apply a hydraulic pressure-based frictional braking force to wheels (four wheels in this embodiment). Each of the wheels is equipped with a brake actuator unit. The brake actuator unit is, for example, a disc-type actuator unit and includes a wheel cylinder 4 and a caliper. The caliper is operated by the hydraulic pressure generated by the wheel cylinder 4 (wheel cylinder hydraulic pressure) to generate the frictional braking force. Wheel cylinders 4F on a front wheels-side (front side) include a wheel cylinder 4FL for a left front wheel and a wheel cylinder 4FR for a right front wheel. Wheel cylinders 4R on a rear wheels-side (rear side) include a wheel cylinder 4RL for a left rear wheel and a wheel cylinder 4RR for a right rear wheel. The brake system 1 includes two brake hydraulic systems that are independent of each other, i.e., a primary system (P system) and a secondary system (S system). In the description below, when a member provided corresponding to the P system and a member provided corresponding to the S system are to be discriminated from each other, a suffix P or S is added to the end of each reference sign.

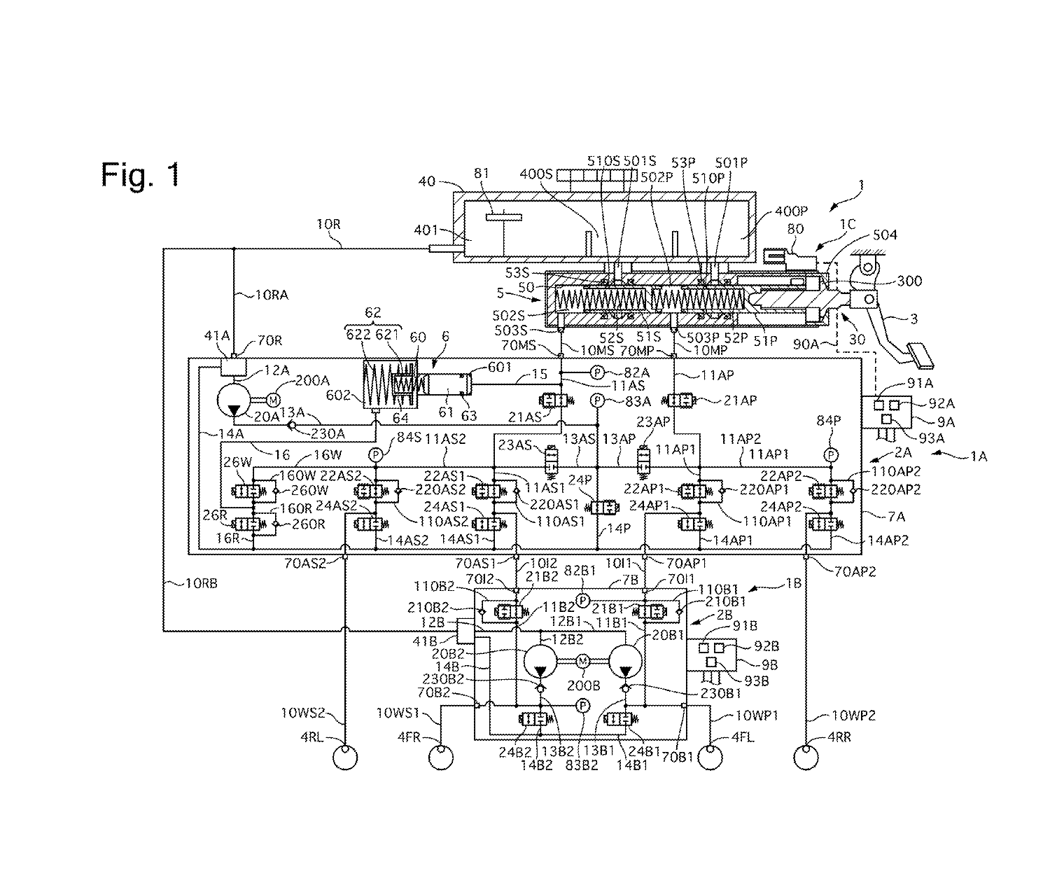

As shown in FIG. 1, the brake system 1 includes a master cylinder unit 1C, a first hydraulic control unit 1A, and a second hydraulic control unit 1B. The units 1A, 1B and 1C are interconnected via a brake piping 10. The brake piping 10 includes a master cylinder piping 10M, a wheel cylinder piping 10W, an intermediate piping 10I, and a reservoir piping 10R. The master cylinder piping 10M includes a piping 10MP of the P system and a piping 10MS of the S system. The wheel cylinder piping 10W includes a first piping 10WP1 and a second piping 10WP2 of the P system and a first piping 10WS1 and a second piping 10WS2 of the S system. The intermediate piping 10I includes a first piping 10I1 and a second piping 10I2. The reservoir piping 10R includes a first piping 10RA and a second piping 10RB. The master cylinder unit 1C is connected to the first hydraulic control unit 1A via the master cylinder pipings 10MP and 10MS and the reservoir piping 10R (first piping 10RA). The master cylinder unit 1C is also connected to the second hydraulic control unit 1B via the reservoir piping 10R (second piping 10RB). The first hydraulic control unit 1A is connected to the wheel cylinder 4RR for the right rear wheel via the second piping 10WP2 of the P system of the wheel cylinder piping 10W, is connected to the wheel cylinder 4RL for the left rear wheel via the second piping 10WS2 of the S system, and is connected to the second hydraulic control unit 1B via the intermediate pipings 10I1 and 10I2. The second hydraulic control unit 1B is connected to the wheel cylinder 4FL for the left front wheel via the first piping 10WP1 of the P system of the wheel cylinder piping 10W, and is connected to the wheel cylinder 4FR for the right front wheel via the first piping 10WS1 of the S system.

The master cylinder unit 1C includes a reservoir tank 40, a master cylinder 5 and a stroke sensor 80. The reservoir tank 40 is a fluid source which reserves the brake fluid, and is a low pressure portion that is open to the atmosphere. A bottom side in the vertical direction of the reservoir tank 40 is parted by partition walls into a P system master cylinder fluid chamber 400P, an S system master cylinder fluid chamber 400S, and a pump fluid chamber 401. The pump fluid chamber 401 is equipped with a sensor 81 which detects the fluid level. The reservoir piping 10R has one end that is connected to the pump fluid chamber 401. The reservoir piping 10R has the other end side that is branched into the first piping 10RA and the second piping 10RB.

The master cylinder 5 is a hydraulic source configured to pressurize the brake fluid in response to a driver's operation of a brake pedal 3 (brake operation) and supply an operating hydraulic pressure (brake hydraulic pressure) to the wheel cylinder 4. The master cylinder 5 is connected to the brake pedal 3 via a push rod 30, and is operated in response to the driver's operation of the brake pedal 3. The master cylinder 5 includes pistons 51 and springs 52. The master cylinder 5 is a tandem type cylinder and includes, as the pistons 51, a primary piston 51P connected to the push rod 30 and a free piston-type secondary piston 51S that are arranged in series. The pistons 51 are placed in a cylinder 50 and define fluid chambers 502. The fluid chambers 502 include a fluid chamber 502P of the P system (first fluid chamber) and a fluid chamber 5025 of the S system (second fluid chamber). Each of the fluid chambers 502 is connected to a supply port 501 and s discharge port 503. A supply port 501P of the first fluid chamber 502P is connected to the fluid chamber 400P of the reservoir tank 40, and a supply port 501S of the second fluid chamber 502S is connected to the fluid chamber 400S of the reservoir tank 40. One end of the master cylinder piping 10MP of the P system is connected to a discharge port 503P of the P system, and one end of the master cylinder piping 10MS of the S system is connected to a discharge port 503S of the S system. The springs 52 are return springs serving to continuously bias the pistons 51 toward the push rod 30-side.

A flange portion 300 of the push rod 30 comes into contact with a stopper portion 504 of the cylinder 50, so as to restrict the motion of the push rod 30 in a biasing direction of the piston 51 by the spring 52. U-packings (ring-shaped seal members having a cup-shaped section) 53 are placed in the cylinder 50 to be in sliding contact with the outer circumferences of the pistons 51. In an initial state that the motion of the push rod 30 is restricted as described above, a hole 510 formed to connect the inner circumference and the outer circumference of the piston 51 with each other communicates with the supply port 501, and the fluid chamber 502 communicates with the fluid chamber 400 of the reservoir tank 40 via the hole 510 and the supply port 501. No hydraulic pressure is accordingly generated in the fluid chamber 502 (i.e., the fluid chamber 502 is kept at atmospheric pressure). When the piston 51 is moved to an opposite side to the biasing direction of the spring 52, the U-packing 53 serves to block the flow of the brake fluid from the fluid chamber 502 toward the supply port 501. A hydraulic pressure (master cylinder hydraulic pressure) is accordingly generated in the fluid chamber 502 that is configured to reduce the volume in response to the motion of the piston 51 (brake depressing operation). The brake fluid is then discharged from the fluid chamber 502 through the discharge port 503 to the master cylinder piping 10M. The U-packing 53 allows for the flow of the brake fluid from the supply port 501 through the outer circumferential side of the piston 51 toward the fluid chamber 502. Thus, when the volume of the fluid chamber 502 is increased in response to the motion of the piston 51 (brake releasing operation), the brake fluid can be supplied from the reservoir tank 40 through the supply port 501 to the fluid chamber 502. The stroke sensor 80 is configured to detect the displacement of the push rod 30 (primary piston 51P) interlocked with the brake pedal 3 (brake operation amount).

The first hydraulic control unit 1A includes a first hydraulic unit 2A, first hydraulic pressure sensors 82A, 83A and 84, and a first control unit 9A. The first hydraulic unit 2A includes a stroke simulator 6, a housing 7A, and actuators. The actuators include a first pump 20A and solenoid valves 21A and the like. The stroke simulator 6 includes a piston 61 and springs 62. The piston 61 is placed in a cylinder 60. The piston 61 parts the inside of the cylinder 60 into a positive pressure chamber 601 and a back pressure chamber 602. An O-ring 63 serving as a seal member is placed on the outer circumference of the piston 61. The O-ring 63 is placed to be in sliding contact with the inner circumference of the cylinder 60 and thereby fluid-tightly separates the two chambers 601 and 602 from each other. The springs 62 are placed in the back pressure chamber 602 to continuously bias the piston 61 toward the positive pressure chamber 601-side. The springs 62 include two springs 621 and 622 having different properties. These springs 621 and 622 are arranged in series via a retainer 64.

A plurality of holes are provided inside of the housing 7A to place therein a plurality of ports 70, a plurality of fluid paths 11 and the like, a fluid reservoir 41A, the stroke simulator 6, and the actuator 20A and the like. The ports 70 include master cylinder ports 70M, first wheel cylinder ports 70A, and a reservoir port 70R. The master cylinder ports 70M include a port 70MP of the P system and a port 70MS of the S system. The first wheel cylinder ports 70A include a first port 70AP1 and a second port 70AP2 of the P system, and a first port 70AS1 and a second port 70AS2 of the S system. The respective other ends of the master cylinder pipings 10MP and 10MS are respectively connected to the master cylinder ports 70MP and 70MS. One end of the second piping 10WP2 of the P system of the wheel cylinder piping 10W is connected to the second port 70AP2 of the P system of the first wheel cylinder ports 70A. One end of the second piping 10WS2 of the S system is connected to the second port 70AS2 of the S system. One end of the first intermediate piping 10I1 is connected to the first port 70AP1 of the P system of the first wheel cylinder ports 70A. One end of the second intermediate piping 10I2 is connected to the first port 70AS1 of the S system.

The fluid paths include first connection fluid paths 11A, a first suction fluid path 12A, a first discharge fluid path 13A, a first pressure reduction fluid path 14A, a simulator positive pressure fluid path 15, and a simulator back pressure fluid path 16. The first connection fluid paths 11A include a fluid path 11AP of the P system and a fluid path 11AS of the S system. The fluid path 11AP of the P system has one end that is connected to the master cylinder port 70MP. The fluid path 11AP has the other end side that is branched into a first fluid path 11AP1 and a second fluid path 11AP2. The first fluid path 11AP1 is connected to the first port 70AP1 of the P system of the first wheel cylinder ports 70A. The second fluid path 11AP2 is connected to the second port 70AP2 of the P system. The fluid path 11AS of the S system has a similar configuration. The first piping 10RA of the reservoir piping 10R is connected to the reservoir port 70R. The fluid reservoir (volume chamber) 41A is connected to the reservoir port 70R. The first suction fluid path 12A has one end that is connected to the fluid reservoir 41A, and the other end that is connected to a suction port of the first pump 20A. The first discharge fluid path 13A has one end that is connected to a discharge port of the first pump 20A. The first discharge fluid path 13A is equipped with a discharge valve 230A. The discharge valve 230A is a check valve configured to suppress the back flow of the brake fluid into the discharge port of the first pump 20A. The other end side of the first discharge fluid path 13A is branched into a fluid path 13AP of the P system and a fluid path 13AS of the S system. The fluid path 13AP is connected to the fluid path 11AP of the P system of the first connection fluid paths 11A, and the fluid path 13AS is connected to the fluid path 11AS of the S system. The first pressure reduction fluid path 14A has one end that is connected to the fluid reservoir 41A. The first pressure reduction fluid path 14A has the other end side that is branched into a fluid path 14P for reducing the discharge hydraulic pressure of the first pump 20A, and fluid paths 14AP of the P system and fluid paths 14AS of the S system for reducing the hydraulic pressure of the wheel cylinder 4. The fluid paths 14AP of the P system include a first fluid path 14AP1 and a second fluid path 14AP2. The first fluid path 14AP1 is connected to the first fluid path 11AP1 of the P system of the first connection fluid paths 11A, and the second fluid path 14AP2 is connected to the second fluid path 11AP2. The fluid paths 14AS of the S system have a similar configuration. The simulator positive pressure fluid path 15 has one end that is connected to the fluid path 11AS of the S system of the connection fluid paths 11A. The simulator positive pressure fluid path 15 has the other end that is connected to the positive pressure chamber 601 of the stroke simulator 6. The simulator back pressure fluid path 16 has one end that is connected to the back pressure chamber 602 of the stroke simulator 6. The simulator back pressure fluid path 16 has the other end side that is branched into a discharge fluid path 16R and a supply fluid path 16W. The discharge fluid path 16R is connected to the first pressure reduction fluid path 14A, and the supply fluid path 16W is connected to the fluid path 11AS of the S system of the connection fluid paths 11A.

The first pump 20A is, for example, a plunger pump and is driven by a first motor 200A. The solenoid valves include first shutoff valves 21A, pressure increase valves 22A, communication valves 23A, first pressure reducing valves 24A, a pressure regulating valve 24P, a simulator-out valve 26R, and a simulator-in valve 26W. The first shutoff valves 21A, the pressure increase valves 22A, and the pressure regulating valve 24P are normally-open valves that are opened in the state in which no electrical power is supplied. The first pressure reducing valves 24A, the communication valves 23A, the simulator-out valve 26W, and the simulator-in valve 26W are normally-closed valves that are closed in the state in which no electrical power is supplied. The first shutoff valves 21A, the pressure increase valves 22A, and the pressure regulating valve 24P are proportional control valves configured such that the valve position is regulated according to the electric current supplied to the solenoid. The communication valves 23A, the first pressure reducing valves 24A, the simulator-out valve 26W, and the simulator-in valve 26W are on-off valves configured such that the valve is controlled and switched between opening and closing in a binary manner. Alternatively, a proportional control valve may be employed for each of these valves.

The first shutoff valve 21A is located on one end side of the first connection fluid path 11A. The first connection fluid path 11A is branched on the first wheel cylinder port 70A-side with respect to the first shutoff valve 21A. The simulator positive pressure fluid path 15 is connected to the fluid path 11AS of the S system at a position between a first shutoff valve 21AS and the master cylinder port 10MS. Pressure increase valves 22AP of the P system are provided respectively in the first fluid path 11AP1 and the second fluid path 11AP2 of the P system of the first connection fluid paths 11A. A bypass fluid path 110AP1 connected to the first fluid path 11AP1 is provided in parallel to the first fluid path 11AP1. The bypass fluid path 110AP1 bypasses a pressure increase valve 22AP1. The bypass fluid path 110AP1 is equipped with a check valve 220AP1. The check valve 220AP1 serves to allow for the flow of the brake fluid from the first wheel cylinder port 70AP1-side toward the master cylinder port 70MP-side and to suppress the flow in a reverse direction. The second fluid path 11AP2 has a similar configuration. Pressure increase valves 22AS of the S system have a similar configuration. The first discharge fluid path 13A (Each of its branched fluid paths 13AP and 13AS) is connected to the first connection fluid path 11A at a position between the first shutoff valve 21A and the pressure increase valve 22A. The first pressure reduction fluid path 14A (Each of its branched fluid paths 14AP and 14AS) is connected to the first connection fluid path 11A (its branched fluid path 11AP or 11AS) at a position between the pressure increase valve 22A and the first wheel cylinder port 70A. The first pressure reducing valves 24A are provided respectively in (first and second fluid paths of) the branched fluid paths 14AP and 14AS of the first pressure reduction fluid path 14A. The communication valves 23A are provided respectively in the branched fluid paths 13AP and 13AS of the first discharge fluid path 13A. The branched fluid path 14P of the first pressure reduction fluid path 14A is connected to the first discharge fluid paths 13A at positions between respective communication valves 23AP and 23AS and the first pump 20A (discharge valve 230A). The pressure regulating valve 24P is provided in the branched fluid path 14P of the first pressure reduction fluid path 14A.

The simulator-out valve 26R is provided in the discharge fluid path 16R of the simulator back pressure fluid path 16. A bypass fluid path 160R connected to the discharge fluid path 16R is provided in parallel to the discharge fluid path 16R. The bypass fluid path 160R bypasses the simulator-out valve 26R. The bypass fluid path 160R is equipped with a check valve 260R. The check valve 260R serves to allow for the flow of the brake fluid from the first pressure reduction fluid path 14A-side toward the back pressure chamber 602-side and to suppress the flow in a reverse direction. The simulator-in valve 26W is provided in the supply fluid path 16W of the simulator back pressure fluid path 16. A bypass fluid path 160W connected to the supply fluid path 16W is provided in parallel to the supply fluid path 16W. The bypass fluid path 160W bypasses the simulator-in valve 26W. The bypass fluid path 160W is equipped with a check valve 260W. The check valve 260W serves to allow for the flow of the brake fluid from the back pressure chamber 602-side toward the first connection fluid path 11A-side (fluid path 11AS-side) and to suppress the flow in a reverse direction.

The first hydraulic pressure sensors 82A, 83A and 84 include a first master cylinder hydraulic pressure sensor 82A, a first pump discharge hydraulic pressure sensor 83A, a P system hydraulic pressure sensor 84P, and an S system hydraulic pressure sensor 84S. The first master cylinder hydraulic pressure sensor 82A is connected to the first connection fluid path 11AS of the S system at a position between the master cylinder port 70MS and the first shutoff valve 21AS. The first pump discharge hydraulic pressure sensor 83A is connected to the first discharge fluid path 13A at a position between the discharge valve 230A and the communication valve 23A. The P system hydraulic pressure sensor 84P is connected to the first connection fluid path 11AP of the P system at a position between a first shutoff valve 21AP and the pressure increase valve 22AP. The S system hydraulic pressure sensor 84S is connected to the first connection fluid path 11AS of the S system at a position between the first shutoff valve 21AS and the pressure increase valve 22AS. The first control unit 9A is placed along with the first hydraulic pressure sensors 82A 83A and 84 in the housing 7A of the first hydraulic unit 2A. The first control unit 9A obtains the input of signals detected by the first hydraulic pressure sensors 82A, 83A and 84. The first control unit 9A is connected to the stroke sensor 80 and the fluid level sensor 81 via signal lines 90A or the like and obtains the input of signals detected by these sensors 80 and 81. The first control unit 9A also receives information from another vehicle-mounted equipment via a vehicle-mounted network such as CAN.

The second hydraulic control unit 1B includes a second hydraulic unit 2B, second hydraulic pressure sensors 82B and 83B, and a second control unit 9B. The second hydraulic unit 2B includes a housing 7B and actuators. The actuators include a second pump 20B and solenoid valves 21B and the like. A plurality of holes are provided inside of the housing 7B to place therein a plurality of ports 70, a plurality of fluid paths 11 and the like and the actuators 20B and the like. The ports 70 include intermediate ports 70I and second wheel cylinder ports 70B. The intermediate ports 70I include a first port 70I1 and a second port 70I2. The second wheel cylinder pots 70B include a first port 70B1 and a second port 70B2. The other end of the first intermediate piping 10I1 is connected to the first port 70I1 of the intermediate ports 70I. The other end of the second intermediate piping 10I2 is connected to the second port 70I2.

The fluid paths include second connection fluid paths 11B, second suction fluid paths 12B, second discharge fluid paths 13B and second pressure reduction fluid paths 14B. Each of these fluid paths has two brake hydraulic systems that are independent of each other, i.e., a first system and a second system. The second connection fluid path 11B has one end side that is connected to the intermediate port 70I. The second connection fluid path 11B has the other end side that is connected to the second wheel cylinder port 70B. One end of the first piping 10WP1 of the P system of the wheel cylinder piping 10W is connected to the port 70B1 of the first system of the second wheel cylinder ports 70B. One end of the first piping 10WS1 of the S system is connected to the port 70B2 of the second system. The housing 7B is provided with a sub reservoir tank (sub tank) 41B. The second piping 10RB of the reservoir piping 10R is connected to the sub tank 41B. The second suction fluid path 12B has one end that is connected to the sub tank 41B. The second suction fluid path 12B has the other end side that is branched into a fluid path 12B1 of the first system and a fluid path 12B2 of the second system. The fluid path 12B1 of the first system is connected to a suction port of a sub pump 20B1 of the first system of the second pump 20B. The fluid path 12B2 of the second system is connected to a suction port of a sub pump 20B2 of the second system. In each of the systems, the second discharge fluid path 13B has one end that is connected to a discharge port of the second pump 20B. The second discharge fluid path 13B has the other end that is connected to the second connection fluid path 11B. The second discharge fluid path 13B is equipped with a discharge valve 230B. The second pressure reduction fluid path 14B has one end that is connected to the sub tank 41B. The second pressure reduction fluid path 14B has the other end side that is branched into a fluid path 14B1 of the first system and a fluid path 14B2 of the second system. The fluid paths 14B1 and 14B2 of the respective systems are connected to the second discharge fluid paths 13B of the corresponding systems. In each system, the second pressure reduction fluid path 14B may not be connected to the second discharge fluid path 13B but may be connected to the second connection fluid path 11B at a position between the shutoff valve 21B and the second wheel cylinder port 70B.

The second pump 20B is, for example, a plunger pump having two plungers and thereby two system sub pumps 20B1 and 20B2. These plungers are driven by one second motor 200B. The solenoid valves include second shutoff valves 21B and second pressure reducing valves 24B. The second shutoff valves 21B are normally-open proportional control valves. The second pressure reducing valves 24B are normally-closed on-off valves. The second shutoff valve 21B is provided in the second connection fluid path 11B. The second discharge fluid path 13B is connected to the second connection fluid path 11B at a position between the second shutoff valve 21B and the second wheel cylinder port 70B. A bypass fluid path 110B connected to the second connection fluid path 11B is provided in parallel to the second connection fluid path 11B. The bypass fluid path 110B bypasses the second shutoff valve 21B. The bypass fluid path 110B is equipped with a check valve 210B. The check valve 210B serves to allow for the flow of the brake fluid from the intermediate port 70I-side toward the second wheel cylinder port 70B-side and to suppress the flow in a reverse direction. According to the embodiment, each of the bypass fluid path and the check valve may be configured by, for example, a clearance between a component that constitutes a valve portion of the solenoid valve and an inner wall of the housing, and a U-packing placed in the clearance. The second pressure reducing valves 24B are provided respectively in the fluid paths 14B1 and 14B2 of the respective systems of the second pressure reduction fluid path 14B.

The second hydraulic pressure sensors 82B and 83B include a second master cylinder hydraulic pressure sensor 82B1 and a second pump discharge hydraulic pressure sensor 83B2. The second master cylinder hydraulic pressure sensor 82B1 is connected to a second connection fluid path 11B1 of the first system at a position between the intermediate port 70I1 and a second shutoff valve 21B1. The second pump discharge hydraulic pressure sensor 83B2 is connected to a second discharge fluid path 13B2 of the second system at a position between a discharge valve 230B2 and the second wheel cylinder port 70B2. The second control unit 9B is placed along with the second hydraulic pressure sensors 82B and 83B in the housing 7B of the second hydraulic unit 2B. The second control unit 9B obtains the input of signals detected by the second hydraulic pressure sensors 82B and 83B. The second control unit 9B is connected to the first control unit 9A via an exclusive wiring or a vehicle-mounted network. The second control unit 9B also receives information from another vehicle-mounted equipment via the vehicle-mounted network such as CAN.

The following describes a control configuration. The first control unit 9A obtains the input of detection values of the stroke sensor 80 and the first hydraulic pressures sensors 82A, 83A and 84 and information regarding the driving conditions from the vehicle side. The unit 9A controls the actuators (the solenoid valves 21 and the like and the motor 200) of the first hydraulic control unit 1A and the second hydraulic control unit 1B, based on the input information and a built-in program. The unit 9A accordingly controls the wheel cylinder hydraulic pressures (hydraulic braking forces) of the respective wheels. The unit 9A controls the wheel cylinder hydraulic pressures to perform various brake controls. The brake controls include, for example, antilock brake control (ABS) to suppress braking-caused slips of the wheels, traction control to suppress driving slips of the wheels, boosting control to reduce the driver's brake operating force, brake control for motion control of the vehicle, automatic brake control such as preceding vehicle following control, regenerative cooperative brake control, and automatic emergency braking (AEB) The motion control of the vehicle includes vehicle behavior stabilization control such as antiskid control. AEB is control that detects the road conditions ahead of an own vehicle and automatically generates a wheel cylinder hydraulic pressure in response to detection of an (expected) collision, in order to avoid the collision with a vehicle ahead or reduce the possible damage of the collision. The unit 9A includes a receiving portion 91A, a computing portion 92A, and a drive portion 93A. The receiving portion 91A receives detection values of the respective sensors 80 and the like and information from the vehicle-mounted network. The computing portion 92A computes a target wheel cylinder hydraulic pressure and performs other operations, based on the information input from the receiving portion 91A. For example, the computing portion 92A detects a displacement (pedal stroke) of the brake pedal 3 as a brake operation amount, based on the detection value of the stroke sensor 80. The computing portion 92A computes commands to drive the actuators (the solenoid valves 21 and the like and the motor 200), in order to achieve the target wheel cylinder hydraulic pressure. The drive portion 93A supplies electric power to the actuators of the first hydraulic control unit 1A in response to command signals from the computing portion 92A.

Under the boosting control, the computing portion 92A sets a target wheel cylinder hydraulic pressure that provides a predetermined boosting ratio or more specifically an ideal characteristic relation between the pedal stroke and the driver's required brake hydraulic pressure (the driver's required vehicle deceleration), based on the detected pedal stroke. Under the regenerative cooperative brake control, the computing portion 92A calculates a target wheel cylinder hydraulic pressure that provides a target deceleration (target braking force) in cooperation with regenerative braking. For example, the computing portion 92A calculates the target wheel cylinder hydraulic pressure such that the sum of a regenerative braking force input from a control unit of a regenerative control device of the vehicle and a hydraulic braking force corresponding to the target wheel cylinder hydraulic pressure satisfies the driver's required vehicle deceleration. Under the ABS, under the traction control, under the brake control for motion control of the vehicle, and under the automatic brake control, the computing portion 92A calculates the target wheel cylinder hydraulic pressure of a wheel as a control object according to a target value of each of these controls (target slip ratio in the ABS and in the traction control, a target yaw rate in the brake control for motion control of the vehicle, and a target vehicle speed or a target deceleration in the automatic brake control). Under the ABS, for example, the computing portion 92A estimates a road surface μ based on the detection value of the wheel cylinder hydraulic pressure and calculates a target wheel cylinder hydraulic pressure that achieves a slip ratio to provide a maximum braking force while preventing the wheel from being locked, based on a predetermined tire model by using information such as a wheel speed or a longitudinal acceleration of the vehicle. Under the brake control for motion control of the vehicle, in order to achieve a desired vehicle moving state, for example, the computing portion 92A calculates a target yaw rate based on a detected or received vehicle motion state quantity (for example, lateral acceleration or vehicle speed) or a detected or received steering angle, and calculates the target wheel cylinder hydraulic pressure of each wheel to make the actual yaw rate equal to the target yaw rate. Under the automatic brake control, in order to assist the driver's brake operation, for example, the computing portion 92A calculates a target deceleration based on driving conditions of the vehicle and information regarding obstacles ahead of the vehicle in addition to the driver's brake operation state, and sets the target wheel cylinder hydraulic pressure of each wheel that achieves the target deceleration. Under the AEB, the computing portion 92A determines whether there is a high possibility of a collision, based on signals from radars, cameras and the like or information from a vehicle-mounted network (signals output from the devices other than the hydraulic control units 1A and 1B and transmitted by CAN). When it is determined that there is a high possibility of a collision, the computing portion 92A sets a wheel cylinder hydraulic pressure that provides a maximum braking force as the target wheel cylinder hydraulic pressure.

The second control unit 9B obtains the input of command signals from the first control unit 9A, detection values of the second hydraulic pressure sensors 82B and 83B, and information regarding the driving conditions from the vehicle side. The unit 9B controls the actuators of the second hydraulic control unit 1B or more specifically controls the open/close operations of the solenoid valves 21B and the like and the rotation speed of the second motor 200B (discharge amount of the second pump 20B), based on the input command signals, or the input information and a built-in program. The unit 9B accordingly controls the wheel cylinder hydraulic pressures (hydraulic braking forces) of the respective wheels connected to the second hydraulic unit 2B. The unit 9B controls the wheel cylinder hydraulic pressure to perform various brake controls. The brake control includes assist control and failure-state brake control. The assist control uses the brake fluid discharged from the second pump 20B to increase a pressure increase gradient of the wheel cylinder hydraulic pressure (braking force) by the first hydraulic control unit 1A. Using the second pump 20B to assist the pressure increase suppresses size expansion of the first pump 20A. The failure-state brake control causes the second hydraulic control unit 1B to continue the brake control in the case of detection of a failure of the first hydraulic control unit 1A or the like. The unit 9B includes a receiving portion 91B, a computing portion 92B, and a drive portion 93B. The receiving portion 91B receives command signals from the first control unit 9A (computing portion 92A), detection values of the respective sensors 82B and the like, and information from the vehicle-mounted network. The computing portion 92B computes a target wheel cylinder hydraulic pressure and performs other operations, based on the information input from the receiving portion 91B. The computing portion 92B computes commands to drive the actuators (the solenoid valves 21B and the like and the motor 200B), in order to achieve the target wheel cylinder hydraulic pressure, and outputs the commands to the drive portion 93B. The drive portion 93B supplies electric power to the actuators of the second hydraulic control unit 1B in response to command signals from the computing portion 92B. The computing portion 92B may compute commands to drive the actuators of the first hydraulic control unit 1A and may output the commands to the first control unit 9A (drive portion 93A).

The computing portion 92A of the first control unit 9A determines whether the pressure increase gradient of the wheel cylinder hydraulic pressure (change gradient of the braking force or the vehicle deceleration) is insufficient under any of various brake controls (for example, boosting control, ABS or AEB). When it is determined that the pressure increase gradient of the wheel cylinder hydraulic pressure is insufficient, the computing portion 92A outputs a command signal to the drive portion 93A of the second control unit 9B to operate the second pump 20B at a predetermined rotation speed for the assist control. Under the failure-state brake control, on the other hand, the computing portion 92B of the second control unit 9B determines whether the first hydraulic control unit 1A has a power supply failure, based on information from the first control unit 9A (a signal of abnormality detected by the first control unit 9A) or information from the vehicle-mounted network. The computing portion 92B also determines whether the fluid paths of the P system or of the S system have a failure such as a fluid leakage in the upstream of the second hydraulic unit 2B, based on the detection values of the respective sensors 82B1 and the like or based on the information from the first control unit 9A and the like. When it is determined that any of such failures occurs, the computing portion 92B detects a master cylinder hydraulic pressure as the brake operation amount, based on the detection value of the second master cylinder hydraulic pressure sensor 82B1. Under the boosting control (by the second hydraulic control unit 1B) at the time of a failure, the computing portion 92B sets the target wheel cylinder hydraulic pressure, based on the detected master cylinder hydraulic pressure. For example, the computing portion 92B sets a target wheel cylinder hydraulic pressure that provides a predetermined boosting ratio or more specifically an ideal characteristic relation between the master cylinder hydraulic pressure and the driver's required brake hydraulic pressure.

With regard to the first control unit 9A and the second control unit 9B, the computing portions 92 and the receiving portions 91 are implemented by software in a microcomputer in the embodiment but may be implemented by electronic circuits. The term “computing” is not limited to arithmetic operation but means the general processing on the software. The receiving portion 91 may be an interface of the microcomputer or may be software in the microcomputer. The drive portion 93 includes, for example, a PWM duty value computing portion and an inverter. The command signal may be a signal regarding a current value or a signal regarding a torque or a displacement. With regard to the computing portion 92A of the first control unit 9A, the target wheel cylinder hydraulic pressure that provides the predetermined boosting ratio is set according to a map in the microcomputer but may be set according to a computing.

The following describes functions. The first hydraulic unit 2A equipped with the first pump 200A includes the master cylinder ports 70M and the first wheel cylinder ports 70A. The master cylinder port 70M serves as a first input port which the brake fluid discharged from the discharge port 503 of the master cylinder 5 enters. Two first wheel cylinder ports 70A are provided for each of the P system and the S system. The brake piping arrangement is an X-shaped arrangement. Accordingly, in each of the P system and the S system, one first wheel cylinder port 70A2 is connected to the rear-side wheel cylinder 4R via a wheel cylinder piping 10W2. This first wheel cylinder port 70A2 serves as a rear-side first output port to deliver the brake fluid entering the master cylinder port 70M or the brake fluid discharged from the first pump 20A toward the rear-side wheel cylinder 4R. The other first wheel cylinder port 70A1 is connected to the front-side wheel cylinder 4F via the intermediate piping 10I, the second hydraulic unit 2B, and a wheel cylinder piping 10W1. This first wheel cylinder port 70A1 serves as a front-side first output port to deliver the brake fluid entering the master cylinder port 70M or the brake fluid discharged from the first pump 20A toward the front-side wheel cylinder 4F. The second hydraulic unit 2B equipped with the second pump 20B includes the intermediate ports 70I and the second wheel cylinder ports 70B. The intermediate port 70I serves as a front-side second input port which the brake fluid delivered from the other first wheel cylinder port 70A1 enters. The second wheel cylinder port 70B serves as a front-side second output port to deliver the brake fluid entering the intermediate port 70I or the brake fluid discharged from the second pump 20B toward the front-side wheel cylinder 4F.

The first hydraulic unit 2A includes the pressure increase valve 22A and the first pressure reducing valve 24A provided in relation to each of the first wheel cylinder ports 70A. Accordingly, the first hydraulic unit 2A is configured to control the supply and the discharge of the brake fluid in each port 70A and to individually control the wheel cylinder hydraulic pressures (braking forces) of the four wheels. The check valve 220A provided in parallel to the pressure increase valve 22A allows for the flow of the brake fluid from the downstream side of the pressure increase valve 22A (first wheel cylinder port 70A-side) to the upstream side (master cylinder port 10M-side) and thereby suppresses the brake fluid from being stuck on the downstream side, even in the event of a closing failure of the pressure increase valve 22A. The first hydraulic unit 2A includes the first shutoff valve 21A provided on the master cylinder 5-side of the connecting position of the first pump 20A (discharge port) in the first connection fluid path 11A. Accordingly, the first hydraulic unit 2A can supply the brake fluid to the respective first wheel cylinder ports 70A by using the first pump 20A, while blocking between the master cylinder 5 and the first pump 20A (discharge port). The first hydraulic unit 2A includes the stroke simulator 6. Accordingly, the first hydraulic unit 2A can cause the brake pedal 3 to stroke in response to the driver's brake operation and can generate a reactive force, even in the state that the first shutoff valve 21A blocks between the master cylinder 5 and the wheel cylinder 4. The first hydraulic unit 2A includes the communication valves 23A. Accordingly, the first hydraulic unit 2A can suppress circulation of the brake fluid between the P system and the S system and maintain these two systems independently of each other. The first hydraulic unit 2A includes the pressure regulating valve 24P. Accordingly, the first hydraulic unit 2A enables the amount of the brake fluid supplied to the first connection fluid path 11A (wheel cylinder hydraulic pressure) to be adjusted with high accuracy by opening and closing the pressure regulating valve 24P in the state that the first pump 20A is operated at a predetermined rotation speed. The first hydraulic unit 2A includes the simulator-out valve 26R. Accordingly, the first hydraulic unit 2A can change over between activation and inactivation of the stroke simulator 6. The check valve 260R provided in parallel to the simulator-out valve 26R allows for the flow of the brake fluid from the fluid reservoir 41A to the back pressure chamber 602 even in the case of a closing failure of the simulator-out valve 26R and thereby facilitates the piston 61 of the stroke simulator 6 to be returned to its initial position. The first hydraulic unit 2A includes the bypass fluid path 160W and the check valve 260W. The brake fluid flowing out from the back pressure chamber 602 of the stroke simulator 6 in response to the driver's brake depressing operation may be supplied to the first connection fluid path 11AS through the check valve 260W. Accordingly, the first hydraulic unit 2A can supply the brake fluid from the back pressure chamber 602 toward the wheel cylinder 4 until the first pump 20A provides a sufficient discharge capacity after a start of operation (while the back pressure chamber 602-side has the higher pressure relative to the check valve 260W than the first connection fluid path 11AS-side). This enhances the pressure increase responsiveness of the wheel cylinder hydraulic pressure of the first pump 20A. The simulator-in valve 26W provided in parallel to the check valve 260W is opened to increase the flow passage area in cross section of the fluid path from the back pressure chamber 602 toward the first connection fluid path 11AS. This further enhances the pressure increase responsiveness. The first hydraulic unit 2A includes the fluid reservoir 41A. Accordingly, the hydraulic unit 2A can use the fluid reservoir 41A as the fluid source (internal reservoir) to continue the hydraulic pressure control by the first pump 20A, even in the case of a fluid leakage or the like from the reservoir piping 10R.

The first control unit 9A is configured to provide pedal force brake. In response to the driver's brake operation, the first control unit 9A inactivates the first pump 20A and controls the first shutoff valve 21A in a valve-opening direction, the pressure increase valve 22A in the valve-opening direction, the communication valve 23A in a valve-closing direction, the first pressure reducing valve 24A in the valve-closing direction, the pressure regulating valve 24P in the valve-opening direction, the simulator-out valve 26R in the valve-closing direction, and the simulator-in valve 26W in the valve-closing direction. This breaks the energization of the respective actuators. This accordingly causes the master cylinder 5 and the wheel cylinder 4 to communicate with each other and enables the wheel cylinder 4 to be pressurized by the master cylinder 5 as the hydraulic source. When the second hydraulic unit 2B is inactive, the second shutoff valve 21B is kept open. This connects the fluid paths from the first wheel cylinder ports 70AP1 and 70AS1 of the first hydraulic unit 2A to the wheel cylinders 4FL and 4FR. Controlling the simulator-out valve 26R in the valve-closing direction inactivates the stroke simulator 6.

Under the boosting control, at the time of the driver's brake operation, the first control unit 9A operates the first pump 20A at a predetermined rotation speed and controls the first shutoff valve 21A in the valve-closing direction, the pressure increase valve 22A in the valve-opening direction, the communication valve 23A in the valve-opening direction, and the first pressure reducing valve 24A in the valve-closing direction. This enables the wheel cylinder 4 to be pressurized by the first pump 20A as the hydraulic source, while shutting off the communication between the master cylinder 5 and the wheel cylinder 4. When the second hydraulic unit 2B is inactive, this connects the fluid paths from the first hydraulic unit 2A (first wheel cylinder ports 70AP1 and 70AS1) to the front-side wheel cylinders 4FL and 4FR. Controlling the simulator-out valve 26R in the valve-opening direction and the simulator-in valve 26W in the valve-closing direction activates the stroke simulator 6. The first control unit 9A controls opening and closing of the pressure regulating valve 24P to make the hydraulic pressure of the first discharge fluid path 13A, which is the hydraulic pressure on the upstream side of the pressure regulating valve 24P, equal to a target hydraulic pressure corresponding to the target wheel cylinder hydraulic pressure. This achieves the target wheel cylinder hydraulic pressure. The hydraulic pressure on the upstream side may be obtained by using any one detection value or a plurality of detection vales (for example, an average value) of the P system hydraulic pressure sensor 84P, the S system hydraulic pressure sensor 84S, and the first pump discharge hydraulic pressure sensor 83A.

The first control unit 9A determines whether the current state is a predetermined sudden braking state in an initial stage of a depressing operation of the brake pedal 3. For example, when the detected amount of change in the pedal stroke per time exceeds a predetermined threshold value, it is determined that the current state is the sudden braking state. When it is determined that the current state is the sudden braking state, the first control unit 9A activates the first pump 20A and controls the first shutoff valve 21A in the valve-closing direction, the pressure increase valve 22A in the valve-opening direction, the communication valve 23A in the valve-opening direction, the first pressure reducing valve 24A in the valve-closing direction, the pressure regulating valve 24P in the valve-closing direction, the simulator-out valve 26R in the valve-closing direction, and the simulator-in valve 26W in the valve-opening direction. This causes the brake fluid flowing out from the back pressure chamber 602 of the stroke simulator 6 activated in response to a depressing operation of the brake pedal 3 to be supplied through the simulator back pressure fluid path 16 (supply fluid path 16W) to the first connection fluid path 11AS (wheel cylinder 4). The brake fluid is supplied from the back pressure chamber 602 to the wheel cylinder 4 until the first pump 20A provides a sufficient discharge capacity after a start of operation. This enhances the pressure increase responsiveness of the wheel cylinder hydraulic pressure. Then, the control is changed over to the boosting control when it is determined that the current state is not the sudden braking state or when a predetermined condition is satisfied to indicate the sufficient discharge capacity of the first pump 20A. In other words, the first control unit 9A controls the simulator-out valve 26R in the valve-opening direction and the simulator-in valve 26W in the valve-closing direction and controls opening and closing of the pressure regulating valve 24P. The first control unit 9A may output a command signal to the second control unit 9B to operate the second pump 20B for the assist control, when it is determined that the discharge capacity of the first pump 20A is insufficient.

Under the ABS, under the brake control for motion control of the vehicle, under the automatic brake control, and under the regenerative cooperative brake control, at the time of the driver's brake operation or no brake operation, the first control unit 9A controls the first shutoff valve 21A in the valve-closing direction and the communication valve 23A in the valve-opening direction. The first control unit 9A operates the first pump 20A at a predetermined rotation speed as needed basis and controls opening and closing of the pressure increase valve 22A or the first pressure reducing valve 24A of a control target wheel, or the pressure regulating valve 24P to decrease, increase or maintain the wheel cylinder hydraulic pressure of the control target wheel and achieve the target wheel cylinder hydraulic pressure. Controlling the simulator-out valve 26R in the valve-opening direction and the simulator-in valve 26W in the valve-closing direction activates the stroke simulator 6. Under the ABS, these valves 26R and 26W may be appropriately opened and closed to adjust the hydraulic pressure in the back pressure chamber 602 and thereby apply an appropriate reactive force to the brake pedal 3. Under the AEB, at the time of the driver's brake operation or no brake operation, the first control unit 9A controls the first shutoff valve 21A in the valve-closing direction, the pressure increase valve 22A in the valve-opening direction, the communication valve 23A in the valve-opening direction, the first pressure reducing valve 24A in the valve-closing direction, and the simulator-in valve 26W in the valve-closing direction. The target wheel cylinder hydraulic pressure is achieved by controlling opening and closing of the pressure regulating valve 24P along with operating the first pump 20A or increasing the rotation speed of the first pump 20A in operation.

The second hydraulic unit 2B includes second connection fluid paths 11B1 and 11B2 of the two systems that are separate from each other, and also includes second discharge fluid paths 13B1 and 13B2 and the second pumps 20B1 and 20B2 provided for the respective systems. Accordingly, the second hydraulic unit 2B is configured to supply the brake fluid to the second wheel cylinder ports 70B1 and 70B2 of the respective systems and to individually control the hydraulic pressures (braking forces) of the wheel cylinders 4FL and 4FR of the respective systems. The second hydraulic unit 2B includes the second shutoff valve 21B provided on the intermediate port 70I-side of the connecting position of (the discharge port side of) the second pump 20B in the second connection fluid path 11B. Accordingly, the second hydraulic unit 2B allows or suppresses the brake fluid entering the intermediate port 70I to be delivered or from being delivered to the second wheel cylinder port 70B, and can supply the brake fluid to the respective second wheel cylinder ports 70B by means of the pump 20B while blocking between the intermediate port 70I and (the discharge port of) the second pump 20B. The second hydraulic unit 2B includes the sub tank 41B. Accordingly, the second hydraulic unit 2B can use the sub tank 41B as the fluid source to continue the hydraulic pressure control by the second pump 20B, even in the case of a fluid leakage or the like from the reservoir piping 10R.

In the situations other than the failure-state brake control, the second control unit 9B keeps the second hydraulic unit 2B inactive unless a command is received from the first control unit 9A. This does not interfere with the pedal force brake or the respective brake controls by the first hydraulic control unit 1A. When receiving command signals from the first control unit 9A, the second control unit 9B drives the actuators of the second hydraulic control unit 1B in response to the command signals. For example, in the situation of assist control, in response to command signals from the first control unit 9A, the second control unit 9B activates the second pump 20B and controls the second shutoff valve 21B in the valve-opening direction and the second pressure reducing valve 24B in the valve-closing direction. The second control unit 9B drives the second pump 20B at a predetermined rotation speed and supplies the brake fluid to the wheel cylinder 4 to increase the pressure increase gradient of the wheel cylinder 4. In the situation of failure-state brake control, the second control unit 9B activates the second pump 20B and controls the second shutoff valve 21B in the valve-closing direction and the second pressure reducing valve 24B in the valve-closing direction. This enables the wheel cylinder 4 of the wheel to be pressurized by the second pump 20B as the hydraulic source, while suppressing the flow of the brake fluid from the second pump 20B to the master cylinder 5.

The second pump discharge hydraulic pressure sensor 83B2 is connected to the fluid path at a position between the wheel cylinder 4FR (second wheel cylinder port 70B2), the second pump 20B2, a second shutoff valve 21B2 and a second pressure reducing valve 24B2 (more specifically, connected to the second discharge fluid path 13B2). The hydraulic pressure detected by the hydraulic pressure sensor 83B2 in the state that the second shutoff valve 21B2 and the second pressure reducing valve 24B2 are closed corresponds to the hydraulic pressure of the wheel cylinder 4FR. It is expected that the sub pumps 20B1 and 20B2 of the two systems of the second pump 20B have identical rotation speeds and that the fluid paths of the two systems (including the wheel cylinders 4F) described above have identical volumes. The hydraulic pressure detected in the second system may thus be used as the hydraulic pressure of the first system. Using the detected hydraulic pressure described above enables the second pump 20B to readily pressurize the wheel cylinders 4F to the target wheel cylinder hydraulic pressure. A second pump discharge hydraulic pressure sensor that is connected at a position between the wheel cylinder 4FL of the first system (second wheel cylinder port 70B1), the sub pump 20B1, the second shutoff valve 21B1, and a second pressure reducing valve 24B1 may be provided in place of the hydraulic pressure sensor 83B2 or in addition to the hydraulic pressure sensor 83B2. Under failure-state boosting control (by the second hydraulic control unit 1B), at the time of the driver's brake operation, the rotation speed of the second pump 20B is controlled to make the hydraulic pressure of the second discharge fluid path 13B detected by the hydraulic pressure sensor 83B2 equal to a target hydraulic pressure corresponding to the target wheel cylinder hydraulic pressure. This achieves the target wheel cylinder hydraulic pressure of the front wheels.

The second master cylinder hydraulic pressure sensor 82B1 is connected to the second connection fluid path 11B1 at the position between the second shutoff valve 21B1 and the master cylinder 5 (intermediate port 70I1). The hydraulic pressure detected by the hydraulic pressure sensor 82B1 in the state that the first hydraulic control unit 1A has a failure (is inactive) and that the second pressure reducing valve 24B is closed corresponds to the master cylinder hydraulic pressure. It is expected that the two fluid chambers 502P and 502S of the master cylinder 5 have identical hydraulic pressures and that the fluid paths of the P system and the S system have identical volumes. The hydraulic pressure detected in the P system may thus be used as the hydraulic pressure of the S system. Under the failure-state boosting control, the target wheel cylinder hydraulic pressure is set, based on the detected master cylinder hydraulic pressure (or its corresponding value). For example, the target wheel cylinder hydraulic pressure is set to satisfy an ideal characteristic relation between the master cylinder hydraulic pressure and the driver's required brake hydraulic pressure. Using the detected hydraulic pressure as described above allows for estimation of the target wheel cylinder hydraulic pressure and enables the second pump 20B to pressurize the wheel cylinder 4F to this target wheel cylinder hydraulic pressure. A second master cylinder hydraulic pressure sensor that is connected to the second connection fluid path 11B2 of the second system at a position between the second shutoff valve 21B2 and the intermediate port 70I2 may be provided in place of the hydraulic pressure sensor 82B1 or in addition to the hydraulic pressure sensor 82B1.

A modification may activate the second pump 20B in place of the first pump 20A to perform the AEB For example, at the time of the driver's brake operation or no brake operation, the second control unit 9B controls the rotation speed of the second pump 20B to make the hydraulic pressure of the second discharge fluid path 13B detected by the hydraulic pressure sensor 83B2 equal to a target hydraulic pressure corresponding to the wheel cylinder hydraulic pressure that provides the maximum braking force. This achieves the target wheel cylinder hydraulic pressure of the front wheels. In another example, the first control unit 9A may control the second shutoff valves 21B1 and 21B2 in the valve-opening direction, output a command signal to the second control unit 9B to operate the second pump 20B at a predetermined rotation speed, and control opening and closing of the pressure regulating valve 24P. This achieves the target wheel cylinder hydraulic pressure of the front wheels with high accuracy.

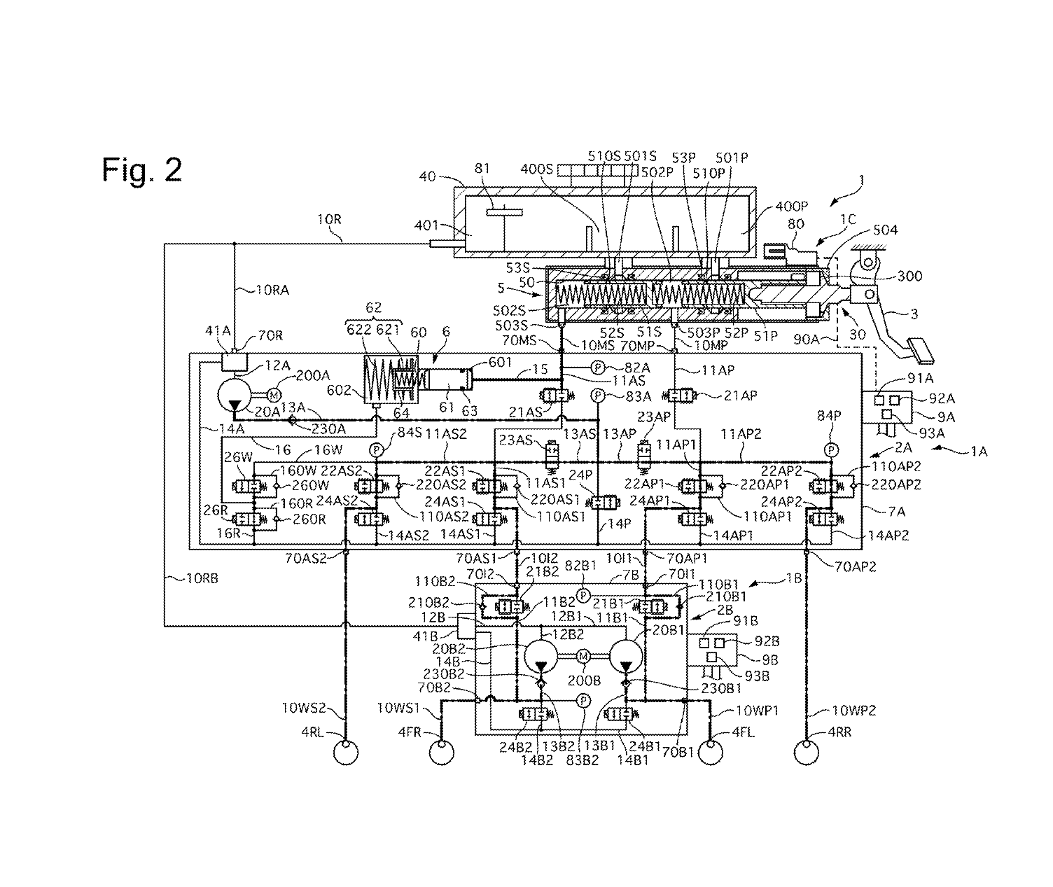

FIG. 2 is a diagram illustrating the operating conditions of the actuators and the flow of the brake fluid when assist control is performed during boosting control by the first hydraulic control unit 1A. The brake fluid discharged from the master cylinder 5 (fluid chamber 502S) is supplied through the master cylinder piping 10MS and the fluid paths 11AS and 15 to the positive pressure chamber 601 of the stroke simulator 6. The inflow of the brake fluid from the master cylinder 5 to the positive pressure chamber 601 in response to the driver's brake operation generates a pedal stroke and causes a reactive force of the driver's brake operation (pedal reactive force) to be generated by the biasing force of the spring 62. The brake fluid discharged from the back pressure chamber 602 of the stroke simulator 6 is supplied through the fluid paths 16 (16R) and 14A to the fluid reservoir 41A. The brake fluid discharged from the first pump 20A is supplied through the fluid paths 13A, 11AP2, and 11AS2 and the second pipings 10WP2 and 10WS2 of the wheel cylinder piping 10W to the wheel cylinders 4RR and 4RL. The brake fluid discharged from the second pump 20B is supplied through the fluid paths 13B, 11B1, and 11B2 and the first pipings 10WP1 and 10WS1 of the wheel cylinder piping 10W to the wheel cylinders 4FL and 4FR. The brake fluid that is discharged from the first pump 20A and enters the intermediate port 70I in the second hydraulic unit 2B may be delivered through the bypass fluid path 110B toward the wheel cylinders 4FL and 4FR. The brake fluid is supplied to the wheel cylinders 4FL and 4FR as long as the hydraulic pressure on the upstream side of the check valve 210B (the first pump 20A-side) is higher than the hydraulic pressure on the downstream side (the second pump 20B-side or the wheel cylinder 4F-side).

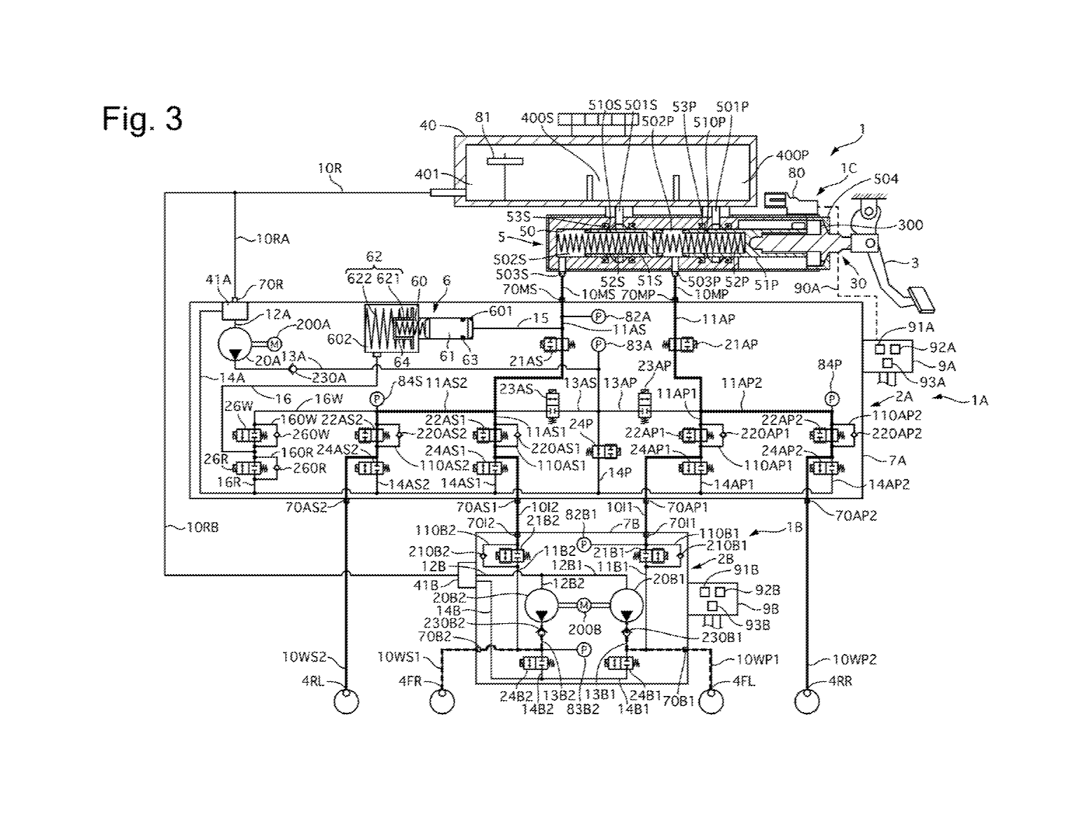

FIG. 3 is a diagram illustrating the operating conditions of the actuators and the flow of the brake fluid when boosting control is performed by the second hydraulic control unit 1B in the event of a power supply failure of the first hydraulic control unit 1A. The first hydraulic control unit 1A is allowed to provide the pedal force brake. The stroke simulator 6 becomes inactive. The brake fluid discharged from the master cylinder 5 is supplied through the fluid paths 11A, 11AP2, and 11AS2 and the second pipings 10WP2 and 10WS2 of the wheel cylinder piping 10W to the wheel cylinders 4RR and 4RL. In other words, the brake fluid discharged from the master cylinder 5 in response to the driver's brake operation is directly flowed into the rear-side wheel cylinder 4R. This generates a hydraulic pressure corresponding to the depressing force in the rear-side wheel cylinder 4R and causes the brake pedal 3 to stroke according to the driver's brake operating force (depressing force). The brake fluid discharged from the second pump 20B is supplied through the fluid paths 13B, 11B1, and 11B2 and the first pipings 10WP1 and 10WS1 of the wheel cylinder piping 10W to the wheel cylinders 4FL and 4FR. The control unit 9B controls the hydraulic pressure of the front-side wheel cylinder 4F so as to be higher than the hydraulic pressure of the rear-side wheel cylinder 4R by using the detection values of the second master cylinder hydraulic pressure sensor 82B1 and the second pump discharge hydraulic pressure sensor 83B2.

The fluid paths 11 and the like, the pumps 20 and the valves 21 and the like of the respective hydraulic units 2A and 2B serve as the hydraulic control device. The fluid paths in the master cylinder pipings 10MP and 10MS, the second fluid paths 11AP2 and 11AS2 of the first connection fluid paths 11A, and the fluid paths in the second pipings 10WP2 and 10WS2 of the wheel cylinder piping 10W serve as rear-side connection fluid paths to connect the master cylinder 5 (fluid chamber 502) with the rear-side wheel cylinders 4RR and 4RL. The fluid paths in the master cylinder pipings 10MP and 10MS, the first fluid paths 11AP1 and 11AS1 of the first connection fluid paths 11A, the fluid paths in the intermediate pipings 10I1 and 10I2, the second connection fluid paths 11B1 and 11B2, and the fluid paths in the first pipings 10WP1 and 10WS1 of the wheel cylinder piping 10W serve as front-side connection fluid paths to connect the master cylinder 5 (fluid chamber 502) with the front-side wheel cylinders 4FL and 4FR. The first pump 20A serves as a first hydraulic source of the hydraulic control device to discharge the brake fluid to one end of the first discharge fluid path 13A. The second pump 20B serves as a second hydraulic source of the hydraulic control device to discharge the brake fluid to one end of the second discharge fluid path 13B. The other end of the first discharge fluid path 13A is connected to the rear-side connection fluid paths (second fluid paths 11AP2 and 11AS2 of the first connection fluid paths 11A) and to the front-side connection fluid paths (first fluid paths 11AP1 and 11AS1 of the first connection fluid paths 11A). The other end of the second discharge fluid path 13B is connected to the front-side connection fluid paths (second connection fluid paths 11B1 and 11B2).

The second discharge fluid path 13B may be connected not to the front-side connection fluid path but to the rear-side connection fluid path. In the embodiment, the second discharge fluid path 13B is connected to the front-side connection fluid path. This arrangement uses the second pump 20B to supply the brake fluid to the front-side wheel cylinder 4F and thereby causes the hydraulic pressure of the front-side wheel cylinder 4F to be higher than the hydraulic pressure of the rear-side wheel cylinder 4R. This increases the braking force of the front wheels while preventing the rear wheels from being locked prior to the front wheels, and thereby ensures the high braking force. In other words, this provides the deceleration of the vehicle more efficiently. This accordingly allows for omission of a booster for assisting the depressing operation force of the brake pedal 3 (for example, a master back using the negative pressure of an internal combustion engine) and improves the mountability of the brake system 1 on the vehicle.

Even in the event of a failure of the first pump 20A that fails to discharge the brake fluid, the second pump 20B can discharge the brake fluid and thereby supply the brake fluid to the wheel cylinder 4. Even in the event of a failure of the second pump 20B that fails to discharge the brake fluid, the first pump 20A can discharge the brake fluid and thereby supply the brake fluid to the wheel cylinder 4. In this manner, even when one of the pumps 20 has a failure to fail to discharge the brake fluid, the other pump 20 is used to continue the brake control. This configuration enhances the reliability of the hydraulic control device (brake system). The hydraulic source is not limited to the pump but may be an accumulator or the like.

The fluid paths 11AP and the like of the P system are connected to the first fluid chamber 502P of the master cylinder 5, and the fluid paths 11AS and the like of the S system are connected to the second fluid chamber 502S. The front-side connection fluid paths include the fluid paths 11AP1 and the like of the P system provided to connect the first fluid chamber 502P with the front-side wheel cylinder 4FL on the left side of the vehicle (one of the left side and the right side), and the fluid paths 11AS 1 and the like of the S system provided to connect the second fluid chamber 502S with the front-side wheel cylinder 4FR on the right side of the vehicle (the other of the left side and the right side). The rear-side connection fluid paths include the fluid paths 11AP2 and the like of the P system provided to connect the first fluid chamber 502P with the rear-side wheel cylinder 4RR on the right side of the vehicle (the other of the left side and the right side), and the fluid paths 11AS2 and the like of the S system provided to connect the second fluid chamber 502S with the rear-side wheel cylinder 4RL on the left side of the vehicle (one of the left side and the right side). In other words, the brake system of the embodiment employs the X-shaped (diagonal-type) brake piping arrangement. The second discharge fluid path 13B is connected to only the front-side connection fluid paths but is not connected to the rear-side connection fluid paths. This configuration enables the second pump 20B to more readily pressurize only the front-side wheel cylinder 4F, compared with a configuration that the second discharge fluid path 13B is connected to both the front-side connection fluid paths and the rear-side connection fluid paths. Even in the case of the X-shaped piping arrangement employed, the configuration that the second discharge fluid path 13B is connected to only the front-side connection fluid paths readily causes the hydraulic pressure of the front-side wheel cylinder 4F to be higher than the hydraulic pressure of the rear-side wheel cylinder 4R, for example, when the first pump 20A has a failure to fail to discharge the brake fluid and the second pump 20B is used to continue the brake control.

The other end of the second discharge fluid path 13B is connected to the front-side connection fluid path at a position between the connecting position of the other end of the first discharge fluid path 13A and the front-side wheel cylinder 4F. In other words, the second pump 20B is connected on the side closer to the front-side wheel cylinder 4F (downstream side) in the front-side connection fluid path, compared with the first pump 20A. This configuration readily reduces a pressure loss in the fluid paths from the second pump 20B to the front-side wheel cylinder 4F, compared with a configuration that the second pump 20B is connected on the side farther from the front-side wheel cylinder 4F (upstream side) compared with the first pump 20A. Reducing the pressure loss improves the pressure increase responsiveness of the hydraulic pressure of the front-side wheel cylinder 4F by the second pump 20B. More specifically, no solenoid valves or the like are provided in the fluid paths from the second pump 20B (discharge valve 230B) to the wheel cylinder 4F. This configuration is free from a pressure loss of the solenoid valves and the like and is thus more likely to improve the pressure increase responsiveness.

The second shutoff valve 21B is provided in the front-side connection fluid path between the connecting position of the other end of the first discharge fluid path 13A and the connecting position of the other end of the second discharge fluid path 13B. The second shutoff valve 21B serves as a front-side solenoid valve to allow for and suppress the flow of the brake fluid from the connecting side of the other end of the first discharge fluid path 13A (upstream side) toward the front-side wheel cylinder 4F-side (downstream side). The second shutoff valve 21B also allows for and suppresses the flow of the brake fluid from the connecting side of the other end of the second discharge fluid path 13B (downstream side) toward the master cylinder 5-side (upstream side). Using the second shutoff valve 21B to suppress the flow of the brake fluid from the downstream side toward the upstream side enables the second pump 20B to efficiently pressurize the front-side wheel cylinder 4F and reduces the effects of the discharge of the brake fluid by the second pump 20B on the hydraulic pressure on the upstream side. Using the second shutoff valve 21B to suppress the flow of the brake fluid from the upstream side toward the downstream side reduces the effects of the discharge of the brake fluid by the first pump 20A on the hydraulic pressure on the downstream side and improves the independency of the hydraulic pressure control by the second pump 20B.

The bypass fluid path 110B is provided to bypass the second shutoff valve 21B and is equipped with the check valve 210B. When the brake fluid is delivered from the first hydraulic unit 2A to the intermediate port 70I simultaneously with activation of the second pump 20B (for example, when the first pump 20A and the second pump 20B are activated simultaneously under the AEB), the brake fluid may be supplied from the upstream side of the second shutoff valve 21B through the bypass fluid path 110B (check valve 210B) to the downstream side. This improves the efficiency of increasing the hydraulic pressure of the wheel cylinder 4. No solenoid valves or the like are provided in the fluid paths from the check valve 210B to the wheel cylinder 4. This configuration is free from a pressure loss of the solenoid valves and the like and is thus more likely to improve the pressure increase responsiveness. Even in the case where the discharge capacity of the second pump 20B differs between the first system and the second system due to some reason, the configuration of supplying the brake fluid from the upstream side of the second shutoff valve 21B through the bypass fluid path 110B (check valve 210B) to the downstream side reduces the difference in the wheel cylinder hydraulic pressure between the respective systems on the downstream side.

The first control unit 9A and the second control unit 9B serve as control units that selectively control the first pump 20A, the second pump 20B and the second shutoff valve 21B. These units 9A and 9B may be integrated. Selectively controlling the first pump 20A, the second pump 20B, and the second shutoff valve 21B can adequately perform the hydraulic pressure control described above. This can adequately perform hydraulic pressure control using the first pump 20A and hydraulic pressure control using the second pump 20B. For example, when the first pump 20A has a failure to fail to discharge the brake fluid, the second shutoff valve 21B is controlled in the valve-closing direction and the second pump 20B is activated. More specifically, the respective units 9A and 9B are separate bodies. The first control unit 9A controls the first pump 20A, and the second control unit 9B controls the second pump 20B. Accordingly, even in the event of a failure of either of the control units 9A and 9B, the other control unit 9 can be used to control the pump 20 to continue the hydraulic pressure control. The second control unit 9B controls the second shutoff valve 21B. This configuration enables the second control unit 9B to control the second shutoff valve 21B in the valve-closing direction and to activate the second pump 20B even in the event of a failure of the first control unit 9A, compared with a configuration that the first control unit 9A controls the second shutoff valve 21B.

The first pump 20A is provided in the first hydraulic unit 2A, and the second pump 20B is provided in the second hydraulic unit 2B. This configuration improves the reliability of the hydraulic control device (brake system) using two hydraulic units 2A and 2B as described below. In the description below, the master cylinder 5-side is called upstream side, and the wheel cylinder 4-side is called downstream side. The first hydraulic unit 2A is a unit configured to individually control the wheel cylinder hydraulic pressures of the four wheels. The first hydraulic unit 2A is connected to the master cylinder 5. The second hydraulic unit 2B is connected on the downstream of the first hydraulic unit 2A. This configuration can reduce a pressure loss in the fluid paths from the second pump 20B to the wheel cylinder 4, compared with a configuration that the second hydraulic unit 2B is connected on the upstream of the first hydraulic unit 2A. More specifically, neither the first shutoff valve 21A nor the pressure increase valve 22A is provided in the fluid paths from the second pump 20B to the wheel cylinder 4. This configuration is free from a pressure loss of these valves and is thus more likely to enhance the pressure increase responsiveness. In other words, there is no need to use the pressure increase valve 22A having a specification of the capacity for the high flow rate for the purpose of reducing the pressure loss. This prevents the poor controllability of the ABS or the like. The number of the pipings 10 in the configuration that the second hydraulic unit 2B is connected on the downstream of the first hydraulic unit 2A is equal to the number of the pipings 10 in the configuration that the second hydraulic unit 2B is connected on the upstream of the first hydraulic unit 2A.

In the event of a failure of the first hydraulic control unit 1A, the second hydraulic unit 2B can supply the controlled hydraulic pressure to the wheel cylinder 4. In the event of a failure of the second hydraulic control unit 1B, the first hydraulic unit 2A can supply the controlled hydraulic pressure to the wheel cylinder 4. In this manner, even in the event of a failure of either one of the hydraulic control units 1A and 1B, the hydraulic unit 2 of the other hydraulic control unit can continue the brake control. This configuration improves the reliability of the hydraulic control device (brake system 1). The control unit 9 is provided for each hydraulic unit 2. Accordingly, even in the event of a power supply failure of one of the hydraulic control units 1A and 1B, the control unit 9 of the other of the hydraulic control units 1A and 1B can continue the brake control.

Only the wheel cylinders 4F for the front wheels out of the four wheels (partial wheels) are connected to the second hydraulic unit 2B. The wheel cylinder 4R for the rear wheel (at least part of the remaining wheels out of the four wheels) is connected to the first hydraulic unit 2A (without via the second hydraulic unit 2B). The first hydraulic unit 2A includes the stroke simulator 6. In the event of a power supply failure of the first hydraulic control unit 1A, the stroke simulator 6 becomes inactive. This state, on the other hand, does not block between the master cylinder port 10M and the first wheel cylinder port 70A and causes the first hydraulic unit 2A to be equivalent to a simple fluid path. The brake fluid discharged from the master cylinder 5 in response to the driver's brake operation directly flows into the wheel cylinder 4R for the rear wheel (at least part of the remaining wheels described above). In other words, the pedal force brake is applied to the rear wheel (at least part of the remaining wheels described above). This causes the brake pedal 3 to stroke according to the driver's brake operating force (depressing force) and generates a hydraulic pressure corresponding to the depressing force in the wheel cylinder 4R. This prevents the driver's operability from being reduced. For example, when the control unit 9 causes the second hydraulic unit 2B to control the wheel cylinder hydraulic pressure according to the driver's brake operating condition, the driver has difficulty in controlling the brake operating condition (i.e., the controlled hydraulic pressure) in the event of a failure in causing the brake pedal 3 to stroke or a failure in generating a reactive force. On the other hand, even when the stroke simulator 6 becomes inactive in the state of a power supply failure of the first hydraulic control unit 1A, the connection of the master cylinder 5 with the wheel cylinder 4R of the rear wheel (at least part of the remaining wheels described above) as described above causes the brake pedal 3 to stroke according to the driver's brake operating force (depressing force) and generates an adequate reactive force. This causes the driver to readily control the brake operating condition (i.e., the controlled hydraulic pressure) and thereby improves the operability. In the event of a power supply failure of the first hydraulic control unit 1A, even when a hydraulic pressure is generated in the rear-side (the remaining wheels-side) wheel cylinder 4R according to the driver's brake operating force (depressing force), the second hydraulic control unit 1B is allowed to control the hydraulic pressure of the front-side (the partial wheels-side) wheel cylinder 4F to be higher than the hydraulic pressure of the rear-side wheel cylinder 4R. This provides the high braking force, while preventing the rear wheels from being locked prior to the front wheels. The case where the second hydraulic control unit 1B is allowed to control the hydraulic pressure of the front-side wheel cylinder 4F to be higher than the hydraulic pressure of the rear-side wheel cylinder 4R includes not only the case where the hydraulic pressure of the rear-side wheel cylinder 4R is equivalent to the master cylinder hydraulic pressure (the case of a power supply failure of the first hydraulic control unit 1A) described above but, for example, the case where no hydraulic pressure is generated in the rear-side wheel cylinder 4R, and the case where the hydraulic pressure of the rear-side wheel cylinder 4R is the hydraulic pressure controlled by the first hydraulic control unit 1A.

The second hydraulic unit 2B is connected in series on the downstream of the first hydraulic unit 2A (i.e., is not connected to the master cylinder 5). The event of a power supply failure of the second hydraulic control unit 1B does not block between the intermediate port 70I of the second hydraulic unit 2B and the second wheel cylinder port 70B and causes the second hydraulic unit 2B to be equivalent to a simple fluid path. The first hydraulic control unit 1A is allowed to continue the brake control for the four wheels and ensures the high braking force. When a further failure such as a fluid leakage occurs in either one of the P system and the S system on the upstream side of the second hydraulic control unit 1B (in the first hydraulic control unit 1A, the intermediate piping 10I or the master cylinder piping 10M), the first hydraulic control unit 1A is allowed to continue the brake control for the wheels of the normal system. This embodiment employs the X-shaped brake piping arrangement, so that the first hydraulic control unit 1A is allowed to continue the hydraulic pressure control of the wheel cylinders 4FR and 4RL in the case of a failure of the P system and to continue the hydraulic pressure control of the wheel cylinders 4FL and 4RR in the case of a failure of the S system.

In the event of a closing failure of the second shutoff valve 21B, controlling the second pressure reducing valve 24B in the valve-opening direction causes the brake fluid to be discharged from the wheel cylinder 4 through the second pressure reducing valve 24B to the sub tank 41B. This reduces the hydraulic pressure of the wheel cylinder 4. It is preferable that the second pressure reducing valve 24B has a specification of the capacity for the high flow rate. This enables the hydraulic pressure of the wheel cylinder 4 to be quickly reduced. The first hydraulic control unit 1A is in charge of the ABS of the front wheels. More specifically, the hydraulic pressure of the front-side wheel cylinder 4F is reduced not by controlling the second pressure reducing valve 24B of the second hydraulic unit 2B in the valve-opening direction but by controlling the first pressure reducing valve 24A of the first hydraulic unit 2A in the valve-opening direction. Accordingly, even when the second pressure reducing valve 24B has the above specification (even when the controllability of the second pressure reducing valve 24B is reduced due to the capacity for the high flow rate), this configuration does not reduce the controllability of the ABS.

For example, a method described below may be employed to detect a closing failure of the second shutoff valve 21B. With a view to detecting a closing failure of the second shutoff valve 21B1 in the first system, the second control unit 9B outputs a command to control the second shutoff valve 21B1 in the valve-opening direction after increasing the hydraulic pressure of the front-side wheel cylinder 4FL in the first system. The first control unit 9A controls the pressure increase valve 22AP1 and the first pressure reducing valve 24AP1 in the valve-closing direction. When an increment of the detection value of the second master cylinder hydraulic pressure sensor 82B1 does not exceed a predetermined threshold value within a predetermined time period after the output of the command to control, for example, the second shutoff valve 21B2 in the valve-opening direction, the second control unit 9B determines that the second shutoff valve 21B1 has a failure of sticking to the valve-closing position. With a view to detecting a closing failure of the second shutoff valve 21B2 in the second system, the second control unit 9B outputs a command to control the second shutoff valve 21B2 in the valve-opening direction after increasing the hydraulic pressure of the front-side wheel cylinder 4FR in the second system. The first control unit 9A controls the first pressure reducing valve 24AS1 in the valve-opening direction. When a decrement of the detection value of the second pump discharge hydraulic pressure sensor 83B2 does not exceed a predetermined threshold value within a predetermined time period after the output of the command to control, for example, the second shutoff valve 21B2 in the valve-opening direction, the second control unit 9B determines that the second shutoff valve 21B2 has a failure of sticking to the valve-closing position.

### Second Embodiment

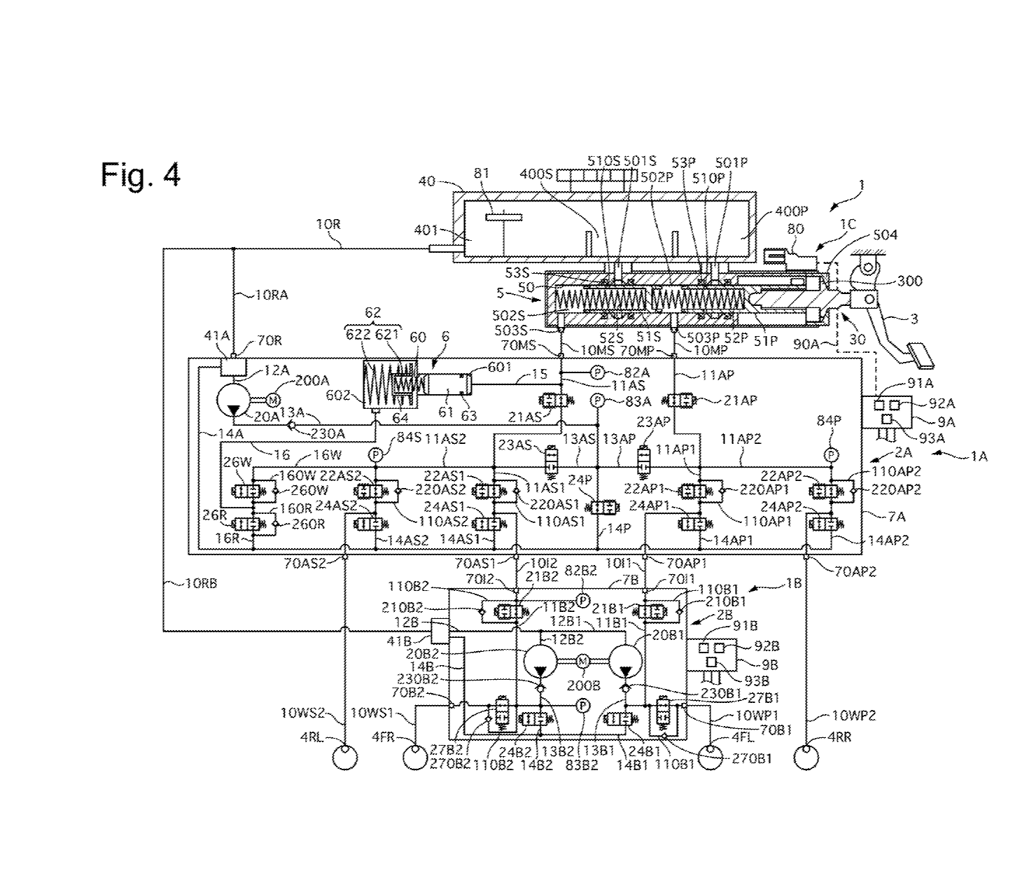

Its configuration is described first. As shown in FIG. 4, a seal valve 27B is provided between the connecting position of the second pressure reduction fluid path 14B and the second wheel cylinder port 70B (front-side wheel cylinder 4F) in both the first system and the second system of the second connection fluid path 11B of the second hydraulic unit 2B. The seal valve 27B is a normally-open solenoid valve and is an on-off valve. A bypass fluid path 110B connected to the second connection fluid path 11B is provided in parallel to the second connection fluid path 11B. The bypass fluid path 110B bypasses the seal valve 27B. The bypass fluid path 110B is equipped with a check valve 270B. The check valve 270B serves to allow for the flow of the brake fluid from the second wheel cylinder port 70B-side toward the second shutoff valve 21B-side and to suppress the flow in a reverse direction. This embodiment does not include the second master cylinder hydraulic pressure sensor 82B1 of the first system but includes a second master cylinder hydraulic pressure sensor 82B2 of the second system. The hydraulic pressure sensor 82B2 is connected to the second connection fluid path 11B2 of the second system at a position between the intermediate port 70I2 and the second shutoff valve 21B2. The control units 9A and 9B are programmed to detect an opening failure of the second pressure reducing valve 24B by using the seal valve 27B.

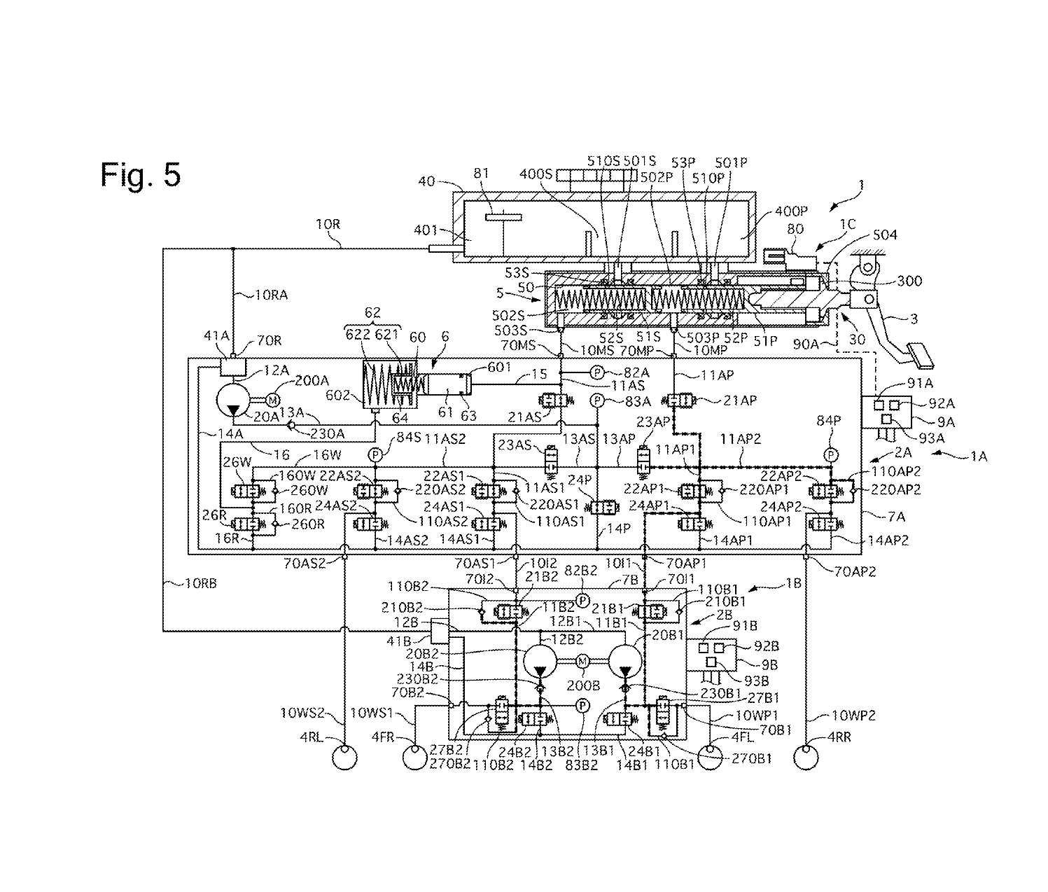

FIG. 5 illustrates the operating conditions of the actuators and the flow of the brake fluid under the control of detecting an opening failure of the second pressure reducing valve 24B. According to a failure detection method of the second pressure reducing valve 24B1 of the first system, the first control unit 9A controls the first shutoff valve 21AP, the communication valve 23AP, the (rear-side) pressure increase valve 22AP2 in the second fluid path 11AP2 of the first connection fluid path 11AP, and the (front-side) first pressure reducing valve 24AP1 in the first fluid path 14AP1 of the first pressure reduction fluid path 14AP in the P system in the valve-closing direction, and the (front-side) pressure increase valve 22AP1 in the first fluid path 11AP1 of the first connection fluid path 11AP in the valve-opening direction. The second control unit 9B outputs a command to control the second shutoff valve 21B1 of the first system in the valve-opening direction and the seal valve 27B1 in the valve-closing direction and to control the second pressure reducing valve 24B1 in the valve-closing direction, and operates the second pump 20B1 at a predetermined rotation speed. In other word, this forms a closed circuit including the second pressure reducing valve 24B1, and the brake fluid is supplied to this closed circuit. The first control unit 9A or the second control unit 9B determines that the second pressure reducing valve 24B1 has a failure of sticking to the valve opening position, when the hydraulic pressure in this closed circuit does not sufficiently rise (for example, when the detection value of the P-system hydraulic pressure sensor 84P does not exceed a predetermined threshold value within a predetermined time period after a start of failure detection control).

According to a failure detection method of the second pressure reducing valve 24B2 of the second system, the second control unit 9B outputs a command to control the second shutoff valve 21B2 and the seal valve 27B2 of the second system in the valve-closing direction and to control the second pressure reducing valve 24B2 in the valve-closing direction, and operates the second pump 20B2 at a predetermined rotation speed. In other words, this forms a closed circuit including the second pressure reducing valve 24B2, and the brake fluid is supplied to this closed circuit. When the hydraulic pressure in this closed circuit does not sufficiently rise (for example, when the detection value of the second pump discharge hydraulic pressure sensor 83B2 does not exceed a predetermined threshold value within a predetermined time period after a start of failure detection control), the second control unit 9B determines that the second pressure reducing valve 24B2 has a failure of sticking to the valve opening position. The other configuration is similar to that of the first embodiment. The like components are expressed by the like reference signs, and their description is omitted.

The following describes the functions. The seal valve 27B is provided in the second connection fluid path 11B at such a position as to suppress the flow of the brake fluid to the second wheel cylinder port 70B. The operation of the seal valve 27B in the valve-closing direction forms the above closed circuit in which the connection with the front-side wheel cylinder 4F is cut off. This configuration enables the occurrence of the failure described above to be determined without pressurizing the front-side wheel cylinder 4F (without generating the braking force).

It is preferable that the seal valve 27B has a specification of the capacity for the high flow rate. This reduces a pressure loss when the brake fluid passes through the seal valve 27B in the fluid paths 11B and the like from the second pump 20B (discharge valve 230B) to the wheel cylinder 4F and thereby enhances the pressure increase responsiveness. The first hydraulic control unit 1A is in charge of the ABS of the front wheels. More specifically, the hydraulic pressure of the front-side wheel cylinder 4F is increased not by controlling the seal valve 27B of the second hydraulic unit 2B in the valve-opening direction but by controlling the pressure increase valve 22A of the first hydraulic unit 2A in the valve-opening direction. Accordingly, even when the seal valve 27B has the above specification (even when the controllability of the seal valve 27B is reduced due to the capacity for the high flow rate), this configuration does not reduce the controllability of the ABS. Even in the case of a closing failure of the seal valve 27B, the check valve 270B provided in parallel to the seal valve 27B allows for the flow of the brake fluid from the downstream side of the seal valve 27B (wheel cylinder 4F-side) toward the upstream side (second shutoff valve 21B-side) and thereby suppresses the brake fluid from being stuck in the downstream side (wheel cylinder 4F-side).

When a second pump discharge hydraulic pressure sensor 83B similar to that of the second system is provided in the first system of the second hydraulic control unit 1B, an opening failure of the second pressure reducing valve 24B1 of the first system is detectable by a similar method to the method with regard to the second system. In this case, the control configuration may be simplified with omission of cooperative control via communication between the first control unit 9A and the second control unit 9B. The method of this embodiment allows for omission of the second pump discharge hydraulic pressure sensor 83B in the first system. With a view to detecting an open failure of the second pressure reducing valve 24B2 in the second system, a closed circuit may be formed by controlling the valves in the first hydraulic unit 2A (the pressure increase valve 22AS1 and the like) like the failure detection method for the second pressure reducing valve 24B1 in the first system, and the hydraulic pressure in this closed circuit may be detected. Otherwise the second embodiment has similar functions and advantageous effects to those of the first embodiment.

### Third Embodiment

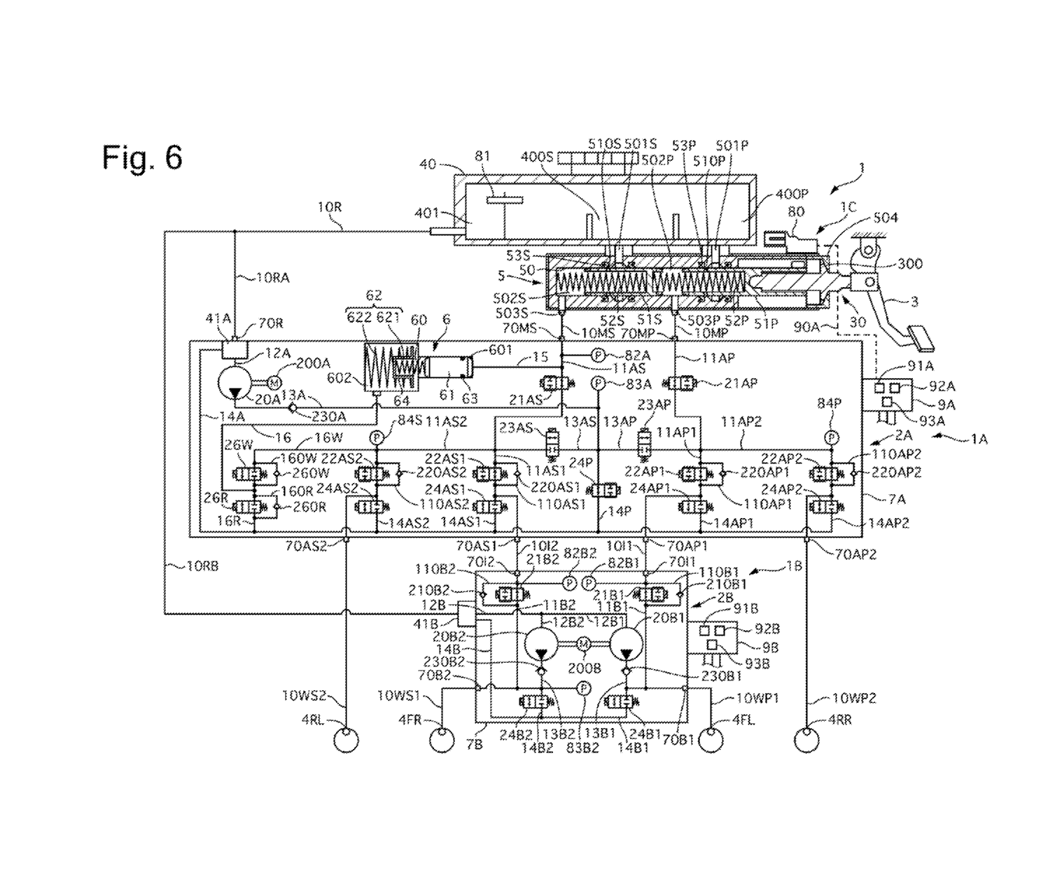

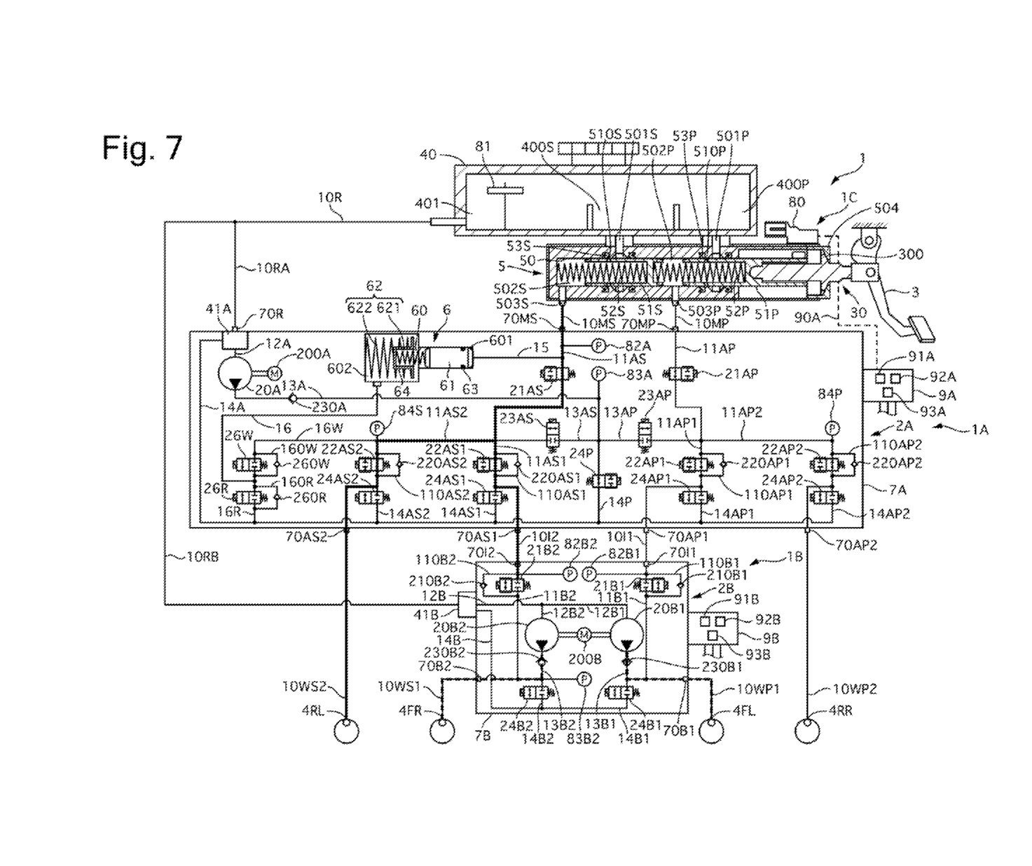

Its configuration is described first. As shown in FIG. 6, the second hydraulic control unit 1B includes the second master cylinder hydraulic pressure sensor 82B1 in the second system (sensor 82B2) as well as in the first system (82B1). The hydraulic pressure sensor 82B2 is connected to the second connection fluid path 11B2 of the second system at a position between the intermediate port 70I2 (or the master cylinder 5) and the second shutoff valve 21B2. The second control unit 9B receives the input of signals detected by both the sensors 82B1 and 82B2. The second control unit 9B controls the second hydraulic unit 2B by using the signal detected by either one of the respective sensors 82B1 and 82B2. FIG. 7 illustrates the operating conditions of the actuators and the flow of the brake fluid when the second hydraulic control unit 1B performs boosting control in the event of a power supply failure of the first hydraulic control unit 1A and a further failure such as a fluid leakage in the P system on the upstream side of the second shutoff valve 21B (in the first hydraulic unit 2A, the intermediate piping 10I or the master cylinder piping 10M). The first hydraulic control unit 1A is allowed to provide the pedal force brake. In the normal S system, the brake fluid discharged from the master cylinder 5 in response to the driver's brake operation flows into the rear-side wheel cylinder 4RL. The second hydraulic control unit 1B uses the detection value of the second master cylinder hydraulic pressure sensor 82B2 of the second system that reflects the hydraulic pressure of the normal S system to control the hydraulic pressures of the front-side wheel cylinders 4FL and 4FR to be higher than the hydraulic pressure of the rear-side wheel cylinder 4RL. The other configuration is similar to that of the first embodiment. The like components are expressed by the like reference signs, and their description is omitted.

The following describes the functions. The second hydraulic unit 2B has the second master cylinder hydraulic pressure sensors 82B in both the first system and the second system. This configuration enables the hydraulic pressures of the respective liquid chambers 502P and 502S (mater cylinder hydraulic pressures) in the master cylinder 5 to be detected. Even in the event of a power supply failure of the first hydraulic control unit 1A and a further failure such as a fluid leakage in either the P system or the S system on the upstream side of the second shutoff valve 21B, the second control unit 9B can identify a normal system, for example, by comparing the detection values of the respective sensors 82B1 and 82B2. The second control unit 9B can use the detection value of the hydraulic pressure sensor 82B that reflects the hydraulic pressure of the normal system to perform hydraulic pressure control of the front-side wheel cylinder 4F in response to the driver's brake operation with regard to the failed system as well as the normal system out of the P system and the S system. Otherwise the third embodiment has similar functions and advantageous effects to those of the first embodiment.

### Fourth Embodiment

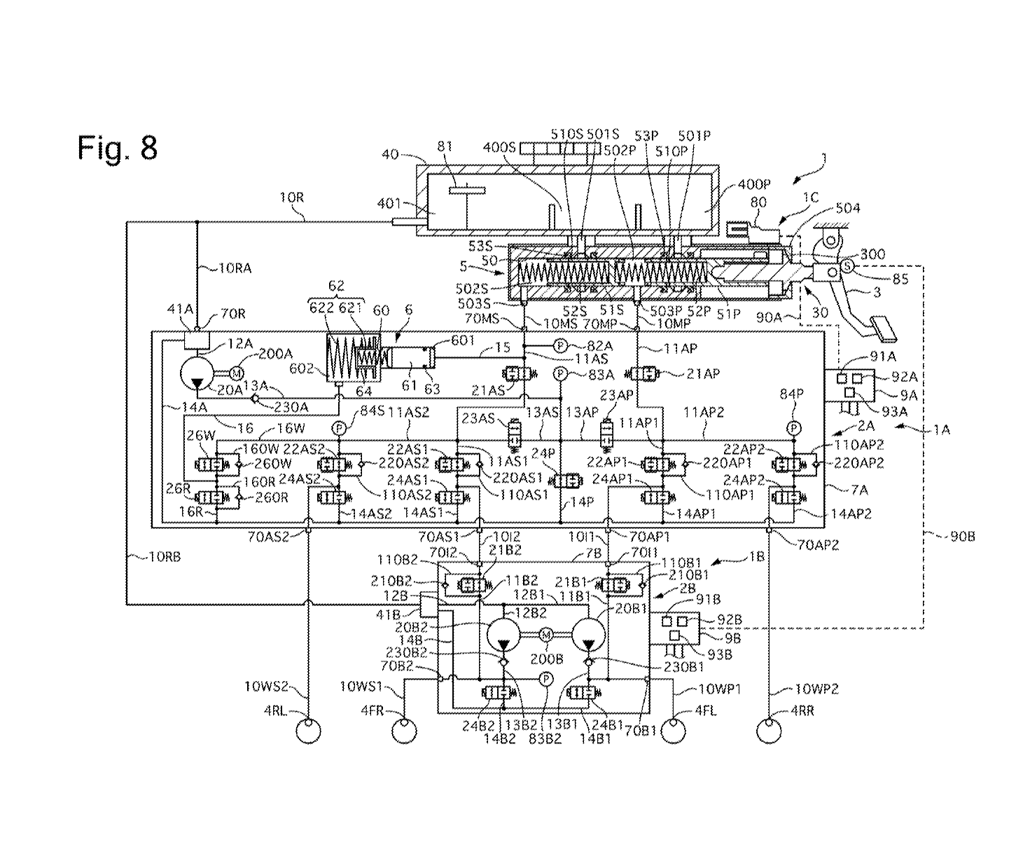

Its configuration is described first. As shown in FIG. 8, the second hydraulic control unit 1B does not include the second master cylinder hydraulic pressure sensor 82B1. The brake pedal 3 is provided with a stroke sensor 85 that detects a stroke (displacement) of the brake pedal 3 as the brake operating condition. The second control unit 9B is connected to the stroke sensor 85 via a signal line 90B and receives the input of a detection signal of the sensor 85. The second control unit 9B can use the detection signal of the sensor 85 to control the second hydraulic unit 2B. The other configuration is similar to that of the first embodiment. The like components are expressed by the like reference signs, and their description is omitted.

The following describes the functions. Even in the event of a failure that generates no hydraulic pressure on the upstream side of the second shutoff valve 21B, the second control unit 9B controls the second shutoff valve 21B in the valve-closing direction and uses the detection value of the sensor 85 to perform hydraulic pressure control of the front-side wheel cylinders 4FL and 4FR in response to the driver's brake operation. This configuration allows for omission of the second master cylinder hydraulic pressure sensor 82B, thus achieving downsizing of the second hydraulic control unit 1B and improving the mountability of the second hydraulic control unit 1B on the vehicle. The sensor connected to the second control unit 9B to detect the brake operating condition is not limited to the stroke sensor 85 but may be a sensor to detect the depressing force input into the brake pedal 3. The second control unit 9B may share the sensor information (for example, the detection value of the stroke sensor 80) of the first control unit 9A, as the signal of the brake operating condition received by the second control unit 9B. Otherwise the fourth embodiment has similar functions and advantageous effects to those of the first embodiment.

### Fifth Embodiment

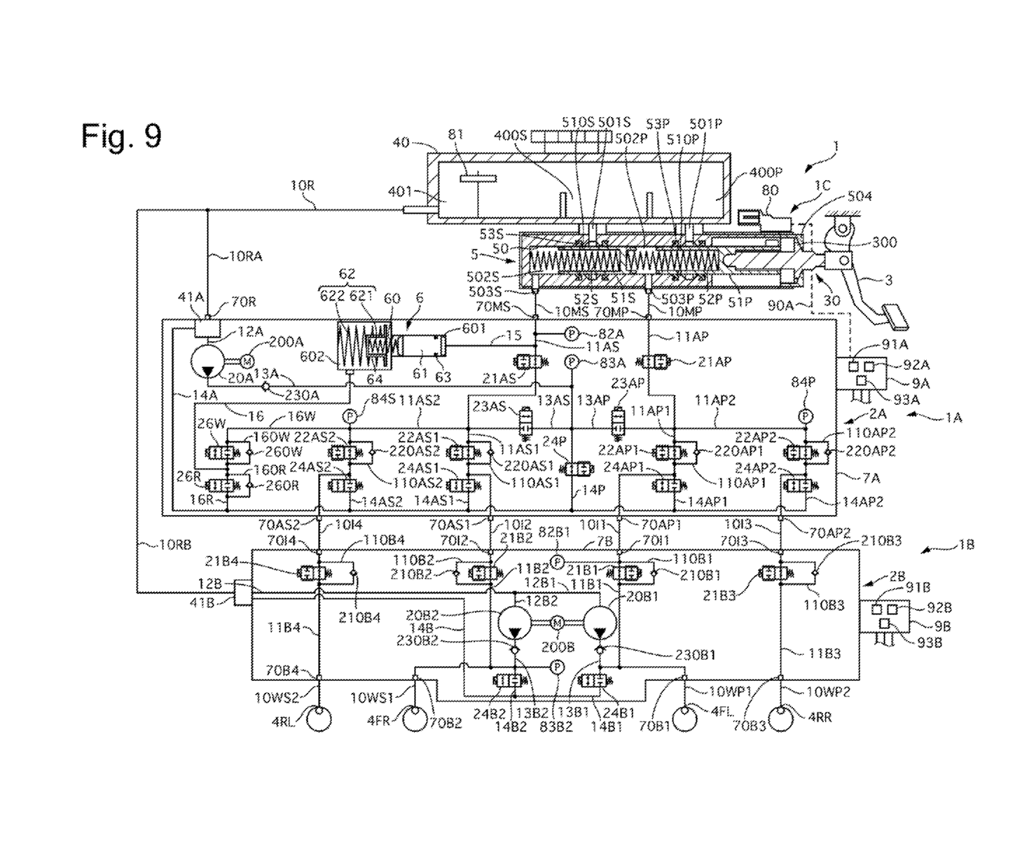

Its configuration is described first. As shown in FIG. 9, in the second hydraulic unit 2B, the intermediate ports 70I include a third port 70I3 and a fourth port 70I4, in addition to the first and the second ports 70I1 and 70I2, and the second wheel cylinder ports 70B include a third port 70B3 and a fourth port 70B4, in addition to the first and the second ports 70B1 and 70B2. The second connection fluid paths 11B include a third fluid path 11B3 and a fourth fluid path 11B4, in addition to the fluid paths 11B1 and 11B2 of the first and the second systems. The third fluid path 11B3 has one end that is connected to the third intermediate port 70I3. The third fluid path 11B3 has the other end that is connected to the third port 70B3 of the second wheel cylinder ports 70B. The fourth fluid path 11B4 has one end that is connected to the fourth intermediate port 70I4. The fourth fluid path 11B4 has the other end that is connected to the fourth port 70B4 of the second wheel cylinder ports 70B. The intermediate piping 10I includes a third piping 10I3 and a fourth piping 10I4, in addition to the first piping 10I1 and the second piping 10I2. The third piping 10I3 has one end that is connected to the second port 70AP2 of the first wheel cylinder ports 70A of the first hydraulic unit 2A. The third piping 10I3 has the other end that is connected to the third intermediate port 70I3 of the second hydraulic unit 2B. The fourth piping 10I4 has one end that is connected to the second port 70AS2 of the second wheel cylinder ports 70A of the first hydraulic unit 2A. The fourth piping 10I4 has the other end that is connected to the fourth intermediate port 70I4 of the second hydraulic unit 2B. One end of the second piping 10WP2 of the P system of the wheel cylinder piping 10W is connected to the third port 70B3 of the second wheel cylinder ports 70B. One end of the second piping 10WS2 of the S system is connected to the fourth port 70B4 of the second wheel cylinder ports 70B.

The second hydraulic unit 2B includes second shutoff valves 21B3 and 21B4, in addition to the second shutoff valves 21B1 and 21B2 of the first and the second systems. The second shutoff valves 21B3 and 21B4 are normally-open proportional control valves. The second shutoff valve 21B3 is provided in the third fluid path 11B3 of the second connection fluid paths 11B, and the second shutoff valve 21B4 is provided in the fourth fluid path 11B4. A bypass fluid path 110B3 connected to the third fluid path 11B3 is provided in parallel to the third fluid path 11B3. The bypass fluid path 110B3 bypasses the second shutoff valve 21B3. The bypass fluid path 110B3 is equipped with a check valve 210B3. The check valve 210B3 serves to allow for the flow of the brake fluid from the second wheel cylinder port 70B3-side toward the third intermediate port 70I3 and to suppress the flow in a reverse direction. The fourth fluid path 11B4 is similarly provided with a bypass fluid path 110B4 and a check valve 210B4.

The second control unit 9B determines whether the rear wheels are likely to be locked prior to the front wheels. Information such as the wheel speeds and the longitudinal acceleration of the vehicle is used for this determination, as in the case of the ABS control. When a master cylinder hydraulic pressure exceeding the discharge capacity of the second pump 20B is generated due to, for example, a sudden depression of the brake pedal 3, the rear-side wheel cylinder 4R is likely to have an excessively high hydraulic pressure (that is higher than the hydraulic pressure of the front-side wheel cylinder 4F). This possibility increases especially when the rear-side wheel cylinder 4R is set to have the smaller capacity than the capacity of the front-side wheel cylinder 4F. The above determination may thus be based on determination of whether the driver provides a sudden brake operation. When determining that the rear wheels are likely to be locked prior to the front wheels, the second control unit 9B controls the second shutoff valves 21B3 and 21B4 in the valve-closing direction. When subsequently determining that there is no such possibility, the second control unit 9B controls the second shutoff valves 21B3 and 21B4 in the valve-opening direction. The other configuration is similar to that of the first embodiment. The like components are expressed by the like reference signs, and their description is omitted.

The following describes the functions. With regard to the third fluid path 11B3 of the second connection fluid paths 11B, the intermediate port 70I3 serves as a rear-side second input port which the brake fluid delivered from the first wheel cylinder port 70AP2 enters. The second wheel cylinder port 70B3 serves as a rear-side second output port to deliver the brake fluid entering the intermediate port 70I3 toward the rear-side wheel cylinder 4RR. The second shutoff valve 21B3 is placed between the third intermediate port 70I3 and the second wheel cylinder port 70B3 (rear-side wheel cylinder 4RR) and serves as a rear-side solenoid valve to allow for and suppress the delivery of the brake fluid entering the intermediate port 70I3 to the second wheel cylinder port 70B3. The fourth fluid path 11B4 has a similar configuration.

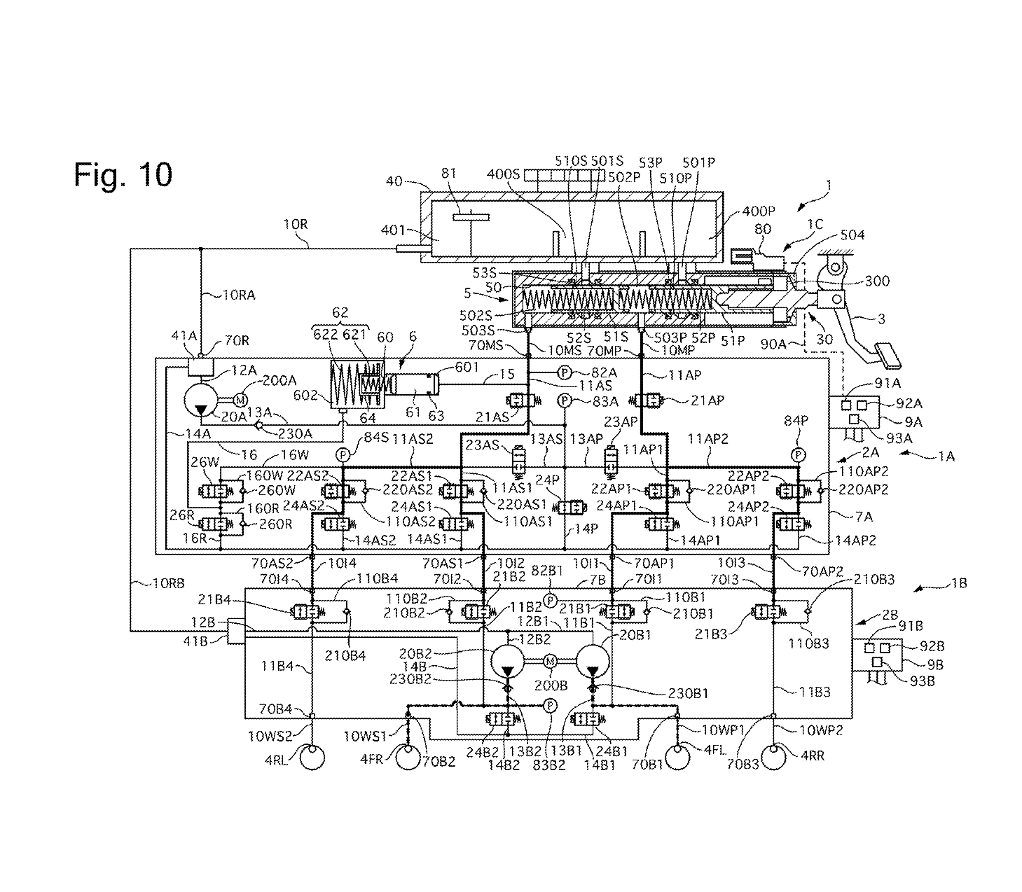

FIG. 10 illustrates the operating conditions of the actuators and the flow of the brake fluid when the second hydraulic control unit 1B performs boosting control in the event of a power supply failure of the first hydraulic control unit 1A. Until the second pump 20B provides a sufficient discharge capacity after a start of operation, it is determined that the rear wheels are likely to be locked prior to the front wheels, and the second shutoff valves 21B3 and 21B4 are controlled in the valve-closing direction. This configuration suppresses the brake fluid from being supplied from the master cylinder 5 to the rear-side wheel cylinders 4RR and 4RL. This configuration accordingly keeps the hydraulic pressures of the rear-side wheel cylinders 4RR and 4RL low until the hydraulic pressures of the front-side wheel cylinders 4FL and 4FR become sufficiently high. This can more reliably suppress the rear wheels from being locked prior to the front wheels. A circuit (including a pressure reducing valve) configured to reduce the hydraulic pressures of the rear-side wheel cylinders 4RR and 4RL may be added between the intermediate port 70I3 and the second wheel cylinder port 70B3 and between the intermediate port 70I4 and the second wheel cylinder port 70B4. The hydraulic pressures of the rear-side wheel cylinders 4RR and 4RL may be (not only maintained but) reduced, for example, by closing the second shutoff valves 21B3 and 21B4 and subsequently opening the pressure reducing valve of this circuit. This configuration can more reliably suppress the rear wheels from being locked prior to the front wheels. Otherwise the fifth embodiment has similar functions and advantageous effects to those of the first embodiment.

### Sixth Embodiment

Its configuration is described first. The first hydraulic control unit 1A is connected to the wheel cylinder 4RR for the right rear wheel via the first piping 10WP1 of the S system of the wheel cylinder piping 10W, and is connected to the wheel cylinder 4RL for the left rear wheel via the second piping 10WS2 of the S system. The second hydraulic control unit 1B is connected to the wheel cylinder 4FL for the left front wheel via the first piping 10WP1 of the P system of the wheel cylinder piping 10W, and is connected to the wheel cylinder 4FR for the right front wheel via the second piping 10WP2 of the P system. One end of the first intermediate piping 10I1 is connected to the second port 70AP2 of the P system of the first wheel cylinder ports 70A, and one end of the second intermediate piping 10I2 is connected to the first port 70AP1 of the P system. One end of the first piping 10WP1 of the P system of the wheel cylinder piping 10W is connected to the port 70B2 of the second system of the second wheel cylinder ports 70B, and one end of the second piping 10WP2 of the P system is connected to the port 70B 1 of the first system. One end of the first piping 10WS1 of the S system of the wheel cylinder piping 10W is connected to the first port 70AS1 of the S system of the first wheel cylinder ports 70A, and one end of the second piping 10WS2 of the S system is connected to the second port 70AS2 of the S system.

The fluid paths in the master cylinder piping 10MS, the fluid paths 11AS1 and 11AS2 of the first connection fluid paths 11A, and the fluid paths in the wheel cylinder pipings 10WS1 and 10WS2 serve as rear-side connection fluid paths to connect the master cylinder 5 (fluid chamber 502) with the rear-side wheel cylinders 4RR and 4RL. The fluid paths in the master cylinder piping 10MP, the fluid paths 11AP1 and 11AP2 of the first connection fluid paths 11A, the fluid paths in the intermediate pipings 10I1 and 10I2, the second connection fluid paths 11B1 and 11B2, and the fluid paths in the wheel cylinder pipings 10WP1 and 10WP2 serve as front-side connection fluid paths to connect the master cylinder 5 (fluid chamber 502) with the front-side wheel cylinders 4FL and 4FR. The front-side connection fluid paths are fluid paths of the P system (one system out of the P system and the S system), and the rear-side fluid paths are fluid paths of the S system (the other system out of the P system and the S system). Accordingly, the brake system of this embodiment employs the front-rear piping arrangement. The other configuration is similar to that of the first embodiment. The like components are expressed by the like reference signs, and their description is omitted.

The following describes the functions. The second discharge fluid paths 13B are connected to only the front-side connection fluid paths (second connection fluid paths 11B1 and 11B2) and are not connected to the rear-side connection fluid paths. Accordingly, the front-rear piping arrangement employed enables the hydraulic pressure of the front-side wheel cylinder 4F to be higher than the hydraulic pressure of the rear-side wheel cylinder 4R under brake control using the second pump 20B, like the first embodiment. Otherwise the sixth embodiment has similar functions and advantageous effects to those of the first embodiment.

### Other Embodiments

The foregoing describes the embodiments of the present invention with reference to drawings. The specific configuration of the present invention is, however, not limited to these embodiments, but changes in design and the like without departing from the spirit of the invention are also included in the present invention. There may be various combinations of respective components or omission of respective components described in the claims and in the description hereof in such an extent that at least part of the problems described above is solved or in such an extent that at least part of the advantageous effects described above are achieved. For example, the number of wheels of the vehicle is not limited to four but may be two or three or may be five or six. The number of connection fluid paths in either or both of the P system and the S system is not limited to two but may be one or three. The number of systems in the second hydraulic unit is not limited to two but may be one or three.

### Other Aspects Understandable from Embodiments

The following describes other aspects understandable from the embodiments described above.

(1) According to one aspect, a hydraulic control device includes a rear-side connection fluid path connecting a master cylinder configured to pressurize a brake fluid in response to an operation of a brake pedal with a rear-side wheel cylinder configured to apply a braking force to a rear wheel of a vehicle according to a brake hydraulic pressure; a front-side connection fluid path connecting the master cylinder with a front-side wheel cylinder configured to apply a braking force to a front wheel of the vehicle according to the brake hydraulic pressure; a first discharge fluid path connected to the rear-side connection fluid path and with the front-side connection fluid path; a first hydraulic source configured to discharge the brake fluid to the first discharge fluid path; a second discharge fluid path connected to the front-side connection fluid path at a position between a connecting position of the first discharge fluid path and the front-side wheel cylinder; a second hydraulic source configured to discharge the brake fluid to the second discharge fluid path; and a normally-open shutoff valve placed between the connecting position of the first discharge fluid path and a connecting position of the second discharge fluid path in the front-side connection fluid path.

(2) According to one preferable aspect, the hydraulic control device of the above aspect further includes a control unit configured to selectively control the first hydraulic source, the second hydraulic source, and the shutoff valve.

(3) According to another preferable aspect, in any of the above aspects, the control unit is configured to control the shutoff valve in a valve-closing direction and drive the second hydraulic source, when the first hydraulic source has a failure.

(4) According to another preferable aspect, in any of the above aspects, the front-side connection fluid path includes front-side connection fluid paths of a primary system and a secondary system. The shutoff valve includes a primary system shutoff valve placed in the front-side connection fluid path of the primary system, and a secondary system shutoff valve placed in the front-side connection fluid path of the secondary system. The hydraulic control device further includes a primary system bypass fluid path connected to the front-side connection fluid path of the primary system to bypass the primary system shutoff valve, a primary system check valve placed in the primary system bypass fluid path and configured to allow for a flow of the brake fluid toward the front-side wheel cylinder, a secondary system bypass fluid path connected to the front-side connection fluid path of the secondary system to bypass the secondary system shutoff valve, and a secondary system check valve placed in the secondary system bypass fluid path and configured to allow for a flow of the brake fluid toward the front-side wheel cylinder.

(5) According to another preferable aspect, in any of the above aspects, the master cylinder includes a first fluid chamber connected to a fluid path of a primary system, and a second fluid chamber connected to a fluid path of a secondary system. The front-side connection fluid path includes a fluid path of the primary system connecting the first fluid chamber with the front-side wheel cylinder on one side in a left-right direction of the vehicle, and a fluid path of the secondary system connecting the second fluid chamber with the front-side wheel cylinder on an opposite side in the left-right direction of the vehicle. The rear-side connection fluid path includes a fluid path of the primary system connecting the first fluid chamber with the rear-side wheel cylinder on the opposite side in the left-right direction, and a fluid path of the secondary system connecting the second fluid chamber with the rear-side wheel cylinder on the one side in the left-right direction.

(6) According to another preferable aspect, in any of the above aspects, the master cylinder includes a first fluid chamber connected to a fluid path of a primary system, and a second fluid chamber connected to a fluid path of a secondary system. The front-side connection fluid path is a fluid path of one system out of the primary system and the secondary system, and the rear-side connection fluid path is a fluid path of the other system out of the primary system and the secondary system.

(7) According to another preferable aspect, the hydraulic control device of any of the above aspects further includes a pressure reduction fluid path connected to the front-side connection fluid path at a position between the shutoff valve and the front-side wheel cylinder or connected to the second discharge fluid path, and connected to a reservoir configured to accumulate the brake fluid; a normally-closed pressure reducing valve placed in the pressure reduction fluid path; and a normally-open solenoid valve placed between a connecting position of the pressure reduction fluid path or a connecting position of the second discharge fluid path and the front-side wheel cylinder in the front-side connection fluid path.

(8) According to another preferable aspect, in any of the above aspects, the front-side connection fluid path includes front-side connection fluid paths of a primary system and a secondary system. The shutoff valve includes a primary system shutoff valve placed in the front-side connection fluid path of the primary system, and a secondary system shutoff valve placed in the front-side connection fluid path of the secondary system. The hydraulic control device further includes a primary system hydraulic pressure sensor placed between the primary system shutoff valve and the master cylinder in the front-side connection fluid path of the primary system, and a secondary system hydraulic pressure sensor placed between the secondary system shutoff valve and the master cylinder in the front-side connection fluid path of the secondary system.

(9) According to another preferable aspect, the hydraulic control device of any of the above aspects further includes a normally-open solenoid valve placed between a connecting position of the first discharge fluid path and the rear-side wheel cylinder in the rear-side connection fluid path.

(10) From another view point, according to one aspect, a hydraulic control device includes a first hydraulic unit and a second hydraulic unit. The first hydraulic unit includes a first input port which a brake fluid discharged from a discharge port of a master cylinder configured to pressurize the brake fluid in response to an operation of a brake pedal enters, a first hydraulic source configured to discharge the brake fluid, a rear-side first output port configured to deliver the brake fluid entering the first input port or the brake fluid discharged from the first hydraulic source toward a rear-side wheel cylinder configured to apply a braking force to a rear wheel of a vehicle according to a brake hydraulic pressure, and a front-side first output port configured to deliver the brake fluid entering the first input port or the brake fluid discharged from the first hydraulic source toward a front-side wheel cylinder configured to apply a braking force to a front wheel of the vehicle according to the brake hydraulic pressure. The second hydraulic unit includes a front-side second input port which the brake fluid delivered from the front-side first output port enters, a second hydraulic source configured to discharge the brake fluid, a front-side second output port configured to deliver the brake fluid entering the front-side second input port or the brake fluid discharged from the second hydraulic source toward the front-side wheel cylinder, and a front-side solenoid valve configured to allow for or suppress delivery of the brake fluid entering the front-side second input port to the front-side second output port.

(11) According to one preferable aspect, the hydraulic control device of the above aspect further includes a control unit configured to selectively control the first hydraulic source, the second hydraulic source, and the front-side solenoid valve.

(12) According to another preferable aspect, in any of the above aspects, the control unit control the front-side solenoid valve in a valve-closing direction and drive the second hydraulic source, when the first hydraulic source has a failure.

(13) According to another preferable aspect, the hydraulic control device of any of the above aspects further includes a first control unit configured to control the first hydraulic source, and a second control unit configured to control the second hydraulic source and the front-side solenoid valve.

(14) According to another preferable aspect, in any of the above aspects, the second control unit is configured to receive a signal from a sensor (brake operating condition detector) configured to detect an operating condition of the brake pedal.

(15) According to another preferable aspect, in any of the above aspects, the second hydraulic unit includes a rear-side second input port which the brake fluid delivered from the rear-side first output port enters, a rear-side second output port configured to deliver the brake fluid entering the rear-side second input port toward the rear-side wheel cylinder configured to apply the braking force to the rear wheel of the vehicle, and a rear-side solenoid valve configured to allow for or suppress delivery of the brake fluid entering the rear-side second input port to the rear-side second output port.

(16) According to one aspect, a brake system includes a first hydraulic unit and a second hydraulic unit. The first hydraulic unit includes a master cylinder unit including a master cylinder configured to pressurize a brake fluid in response to a brake operation, a first input port which the brake fluid discharged from a discharge port of the master cylinder enters, a first hydraulic source configured to discharge the brake fluid, a rear-side first output port configured to deliver the brake fluid entering the first input port or the brake fluid discharged from the first hydraulic source toward a rear-side wheel cylinder configured to apply a braking force to a rear wheel of a vehicle according to a brake hydraulic pressure, and a front-side first output port configured to deliver the brake fluid entering the first input port or the brake fluid discharged from the first hydraulic source toward a front-side wheel cylinder configured to apply a braking force to a front wheel of the vehicle according to the brake hydraulic pressure. The second hydraulic unit includes a front-side second input port which the brake fluid delivered from the front-side first output port enters, a second hydraulic source configured to discharge the brake fluid, a front-side second output port configured to deliver the brake fluid entering the front-side second input port or the brake fluid discharged from the second hydraulic source toward the front-side wheel cylinder, and a shutoff valve configured to allow for or suppress delivery of the brake fluid entering the front-side second input port to the front-side second output port.

(17) According to one preferable aspect, the brake system of the above aspect further includes a control unit configured to selectively control the first hydraulic source, the second hydraulic source, and the shutoff valve.

(18) According to another preferable aspect, in any of the above aspects, the control unit is configured to control the shutoff valve in a valve-closing direction and drive the second hydraulic source, when the first hydraulic source has a failure.

(19) According to another preferable aspect, in any of the above aspects, the control unit is configured to control the shutoff valve in a valve-closing direction and drive the second hydraulic source, when the first hydraulic source has a failure.

(20) According to another preferable aspect, in any of the above aspects, the second control unit is configured to receive a signal from a sensor configured to detect a condition of the brake operation.

The present application claims priority to Japanese patent application No. 2016-171366 filed on Sep. 2, 2016. The entirety of the disclosure including the description, the claims, the drawings and the abstract of Japanese patent application No. 2016-171366 filed on Sep. 2, 2016 is hereby incorporated by reference into this application.

### REFERENCE SIGNS LIST

1 brake system, 1C master cylinder unit, 2A first hydraulic unit, 2B second hydraulic unit, 3 brake pedal, 4R rear-side wheel cylinder, 4F front-side wheel cylinder, 5 master cylinder, 503 discharge port, 11A first connection fluid path, 11B second connection fluid path, 13A first discharge fluid path, 13B second discharge fluid path, 20A first pump (first hydraulic source), 20B second pump (second hydraulic source), 21B second shutoff valve

1. A hydraulic control device comprising:
a rear-side connection fluid path connecting a master cylinder configured to pressurize a brake fluid in response to an operation of a brake pedal with a rear-side wheel cylinder configured to apply a braking force to a rear wheel of a vehicle according to a brake hydraulic pressure;
a front-side connection fluid path connecting the master cylinder with a front-side wheel cylinder configured to apply a braking force to a front wheel of the vehicle according to the brake hydraulic pressure;
a first discharge fluid path connected to the rear-side connection fluid path and to the front-side connection fluid path;
a first hydraulic source configured to discharge the brake fluid to the first discharge fluid path;
a second discharge fluid path connected to the front-side connection fluid path at a position between a connecting position of the first discharge fluid path and the front-side wheel cylinder;
a second hydraulic source configured to discharge the brake fluid to the second discharge fluid path; and
a normally-open shutoff valve placed between the connecting position of the first discharge fluid path and a connecting position of the second discharge fluid path in the front-side connection fluid path.

2. The hydraulic control device according to claim 1, further comprising:
a control unit configured to selectively control the first hydraulic source, the second hydraulic source, and the shutoff valve.

3. The hydraulic control device according to claim 2,
wherein the control unit is configured to control the shutoff valve in a valve-closing direction and drive the second hydraulic source, when the first hydraulic source has a failure.

4. The hydraulic control device according to claim 1,
wherein the front-side connection fluid path comprises front-side connection fluid paths of a primary system and a secondary system,
the shutoff valve comprises:
a primary system shutoff valve placed in the front-side connection fluid path of the primary system; and
a secondary system shutoff valve placed in the front-side connection fluid path of the secondary system, and
the hydraulic control device further comprising:
a primary system bypass fluid path connected to the front-side connection fluid path of the primary system to bypass the primary system shutoff valve;
a primary system check valve placed in the primary system bypass fluid path and configured to allow for a flow of the brake fluid toward the front-side wheel cylinder;
a secondary system bypass fluid path connected to the front-side connection fluid path of the secondary system to bypass the secondary system shutoff valve; and
a secondary system check valve placed in the secondary system bypass fluid path and configured to allow for a flow of the brake fluid toward the front-side wheel cylinder.

5. The hydraulic control device according to claim 1,
wherein the master cylinder comprises a first fluid chamber connected to a fluid path of a primary system, and a second fluid chamber connected to a fluid path of a secondary system, wherein
the front-side connection fluid path comprises:
a fluid path of the primary system connecting the first fluid chamber with the front-side wheel cylinder on one side in a left-right direction of the vehicle; and
a fluid path of the secondary system connecting the second fluid chamber with the front-side wheel cylinder on an opposite side in the left-right direction of the vehicle, and
the rear-side connection fluid path comprises:
a fluid path of the primary system connecting the first fluid chamber with the rear-side wheel cylinder on the opposite side in the left-right direction; and
a fluid path of the secondary system connecting the second fluid chamber with the rear-side wheel cylinder on the one side in the left-right direction.

6. The hydraulic control device according to claim 1,
wherein the master cylinder comprises a first fluid chamber connected to a fluid path of a primary system, and a second fluid chamber connected to a fluid path of a secondary system, wherein
the front-side connection fluid path is a fluid path of one system out of the primary system and the secondary system, and
the rear-side connection fluid path is a fluid path of the other system out of the primary system and the secondary system.

7. The hydraulic control device according to claim 1, further comprising:
a pressure reduction fluid path connected to the front-side connection fluid path at a position between the shutoff valve and the front-side wheel cylinder or connected to the second discharge fluid path, and connected to a reservoir configured to accumulate the brake fluid;
a normally-closed pressure reducing valve placed in the pressure reduction fluid path; and
a normally-open solenoid valve placed between a connecting position of the pressure reduction fluid path or a connecting position of the second discharge fluid path and the front-side wheel cylinder in the front-side connection fluid path.

8. The hydraulic control device according to claim 1,
wherein the front-side connection fluid path comprises front-side connection fluid paths of a primary system and a secondary system, and
the shutoff valve comprises:
a primary system shutoff valve placed in the front-side connection fluid path of the primary system; and
a secondary system shutoff valve placed in the front-side connection fluid path of the secondary system, and
the hydraulic control device further comprising:
a primary system hydraulic pressure sensor placed between the primary system shutoff valve and the master cylinder in the front-side connection fluid path of the primary system; and
a secondary system hydraulic pressure sensor placed between the secondary system shutoff valve and the master cylinder in the front-side connection fluid path of the secondary system.

9. The hydraulic control device according to claim 1, further comprising:
a normally-open solenoid valve placed between a connecting position of the first discharge fluid path and the rear-side wheel cylinder in the rear-side connection fluid path.

10. A hydraulic control device comprising:
a first hydraulic unit; and
a second hydraulic unit, wherein
the first hydraulic unit comprises:
a first input port which a brake fluid discharged from a discharge port of a master cylinder configured to pressurize the brake fluid in response to an operation of a brake pedal enters;
a first hydraulic source configured to discharge the brake fluid;
a rear-side first output port configured to deliver the brake fluid entering the first input port or the brake fluid discharged from the first hydraulic source toward a rear-side wheel cylinder configured to apply a braking force to a rear wheel of a vehicle according to a brake hydraulic pressure; and
a front-side first output port configured to deliver the brake fluid entering the first input port or the brake fluid discharged from the first hydraulic source toward a front-side wheel cylinder configured to apply a braking force to a front wheel of the vehicle according to the brake hydraulic pressure, and
the second hydraulic unit comprises:
a front-side second input port which the brake fluid delivered from the front-side first output port enters;
a second hydraulic source configured to discharge the brake fluid;
a front-side second output port configured to deliver the brake fluid entering the front-side second input port or the brake fluid discharged from the second hydraulic source toward the front-side wheel cylinder; and
a front-side solenoid valve configured to allow for or suppress delivery of the brake fluid entering the front-side second input port to the front-side second output port.

11. The hydraulic control device according to claim 10, further comprising:
a control unit configured to selectively control the first hydraulic source, the second hydraulic source, and the front-side solenoid valve.

12. The hydraulic control device according to claim 11,
wherein the control unit is configured to control the front-side solenoid valve in a valve-closing direction and drive the second hydraulic source, when the first hydraulic source has a failure.

13. The hydraulic control device according to claim 10, further comprising:
a first control unit configured to control the first hydraulic source; and
a second control unit configured to control the second hydraulic source and the front-side solenoid valve.

14. The hydraulic control device according to claim 13,
wherein the second control unit is configured to receive a signal from a sensor configured to detect an operating condition of the brake pedal.

15. The hydraulic control device according to claim 10,
wherein the second hydraulic unit comprises:
a rear-side second input port which the brake fluid delivered from the rear-side first output port enters;
a rear-side second output port configured to deliver the brake fluid entering the rear-side second input port toward the rear-side wheel cylinder configured to apply the braking force to the rear wheel of the vehicle; and
a rear-side solenoid valve configured to allow for or suppress delivery of the brake fluid entering the rear-side second input port to the rear-side second output port.

16. A brake system comprising:
a first hydraulic unit; and
a second hydraulic unit, wherein
the first hydraulic unit comprises:
a master cylinder unit including a master cylinder configured to pressurize a brake fluid in response to a brake operation;
a first input port which the brake fluid discharged from a discharge port of the master cylinder enters;
a first hydraulic source configured to discharge the brake fluid;
a rear-side first output port configured to deliver the brake fluid entering the first input port or the brake fluid discharged from the first hydraulic source toward a rear-side wheel cylinder configured to apply a braking force to a rear wheel of a vehicle according to a brake hydraulic pressure; and
a front-side first output port configured to deliver the brake fluid entering the first input port or the brake fluid discharged from the first hydraulic source toward a front-side wheel cylinder configured to apply a braking force to a front wheel of the vehicle according to the brake hydraulic pressure, and
the second hydraulic unit comprises:
a front-side second input port which the brake fluid delivered from the front-side first output port enters;
a second hydraulic source configured to discharge the brake fluid;
a front-side second output port configured to deliver the brake fluid entering the front-side second input port or the brake fluid discharged from the second hydraulic source toward the front-side wheel cylinder; and
a shutoff valve configured to allow for or suppress delivery of the brake fluid entering the front-side second input port to the front-side second output port.

17. The brake system according to claim 16, further comprising:
a control unit configured to selectively control the first hydraulic source, the second hydraulic source, and the shutoff valve.

18. The brake system according to claim 17,
wherein the control unit is configured to control the shutoff valve in a valve-closing direction and drive the second hydraulic source, when the first hydraulic source has a failure.

19. The brake system according to claim 16; further comprising:
a first control unit configured to control the first hydraulic source; and
a second control unit configured to control the second hydraulic source and the front-side solenoid valve.

20. The brake system according to claim 19,
wherein the second control unit is configured to receive a signal from a sensor configured to detect an operating condition of the brake pedal.
